(19) United States
(12) Patent Application Publication
(10) Pub. No.: US 2024/0049056 A1
(43) Pub. Date: Feb. 8, 2024

(54) TERMINAL DEVICE, MULTI-LINK COMMUNICATION METHOD, AND CHIP

(71) Applicant: HUAWEI TECHNOLOGIES CO., LTD., Shenzhen, Guangdong (CN)

(72) Inventors: Haw-Wei SHU, Shanghai (CN); Tongbo WANG, Shanghai (CN); Ming ZHOU, Shanghai (CN); Ronggui XIE, Shanghai (CN)

(21) Appl. No.: 18/257,425

(22) PCT Filed: Dec. 9, 2021
(86) PCT No.: PCT/CN2021/136900

§ 371 Date: Jun. 14, 2023

(30) Foreign Application Priority Data
Dec. 16, 2020 (CN) 202011487870.8

(51) Int. Cl. H04W 28/08; H04W 76/15; H04W 28/02; H04W 72/543

(52) U.S. Cl. CPC H04W 28/0975; H04W 76/15; H04W 28/0215; H04W 72/543

(57) ABSTRACT

The present disclosure relates to terminal devices, multi-link communication methods, and chips. In one example method, when a terminal device supports Wi-Fi and D2D (for example, V2X) communication, the terminal device may communicate with another terminal device in a multi-link collaborative transmission manner such as a Wi-Fi link and a D2D link to implement multi-link accelerated transmission in a local area network.

This application claims priority to Chinese Patent Application No. 202011487870.8, filed with the China National Intellectual Property Administration on Dec. 16, 2020 and entitled “TERMINAL DEVICE, MULTI-LINK COMMUNICATION METHOD, AND CHIP”, which is incorporated herein by reference in its entirety.

### TECHNICAL FIELD

This application relates to the field of communication technologies, and in particular, to a terminal device, a multi-link communication method, and a chip.

### BACKGROUND

Currently, in a device-to-device local area network communication process, point-to-point communication may be established between terminal devices (for example, mobile phones) by using a wireless fidelity (wireless fidelity, Wi-Fi) network. For example, when a file is shared by using Huawei Share, data such as voice, a video, and/or a text may be transmitted between mobile phones by establishing a Wi-Fi data channel. However, when a communication environment is poor, for example, interference is strong, a signal is weak, a resource is insufficient, or a load is large, data transmission between terminal devices may be affected, and problems of a low data transmission speed and a long transmission delay occur.

### SUMMARY

This application provides a terminal device, a multi-link communication method, and a chip, to resolve problems of a low data transmission speed and a long transmission delay in a current device-to-device communication process.

To achieve the foregoing objectives, the following technical solutions are used in this application.

According to a first aspect, this application provides a terminal device, where the terminal device includes a wireless fidelity Wi-Fi chip and a device-to-device (device-to-device, D2D) chip. The terminal device is referred to as a first terminal device, and a device communicating with the terminal device is referred to as a second terminal device.

The Wi-Fi chip is configured to: when the first terminal device processes a preset service, establish a first communication link to the second terminal device, and transmit target data streams between the first terminal device and the second terminal device by using the first communication link.

The D2D chip is configured to: when the first terminal device processes the preset service, establish a second communication link to the second terminal device, and transmit the target data streams between the first terminal device and the second terminal device by using the second communication link.

The first communication link includes at least one Wi-Fi link that complies with a Wi-Fi protocol, the second communication link includes at least one D2D link that complies with a D2D sidelink (sidelink, SL) protocol, the target data streams are data streams corresponding to the preset service, and the preset service is a unidirectional data transmission service or a bidirectional data transmission service.

According to the foregoing solution, when the terminal device supports Wi-Fi and D2D (for example, V2X) communication, the terminal device may communicate with another terminal device in a multi-link collaborative transmission manner such as a Wi-Fi link and a D2D link, to implement multi-link accelerated transmission in a local area network. This may improve data transmission stability, increase data transmission rate, and reduce delay. In embodiments of this application, device-to-device transmission acceleration is implemented through multi-network and multi-link collaborative transmission, to resolve problems of a low data transmission speed and a long transmission delay in a current device-to-device communication process, and improve user service experience.

D2D communication is device-to-device communication, and means that data may be directly transmitted between different terminal devices without using a network device (for example, a base station). Compared with another direct connection technology (for example, Wi-Fi or Bluetooth) that does not depend on infrastructure network facilities, D2D communication is more flexible. Connection and resource allocation may be performed under control of a base station, or information exchange may be performed in a scenario without network infrastructure.

Optionally, the target data streams may be transmitted between the first terminal device and the second terminal device by using one Wi-Fi link and one D2D link. Alternatively, the target data streams may be transmitted between the first terminal device and the second terminal device by using a plurality of Wi-Fi links and one D2D link. Alternatively, the target data streams may be transmitted between the first terminal device and the second terminal device by using one Wi-Fi link and a plurality of D2D links. Alternatively, the target data streams may be transmitted between the first terminal device and the second terminal device by using a plurality of Wi-Fi links and a plurality of D2D links.

It should be noted that the second terminal device also includes a Wi-Fi chip and a D2D chip. At least one Wi-Fi link may be established between the Wi-Fi chip of the first terminal device and the Wi-Fi chip of the second terminal device, and at least one D2D link may be established between the D2D chip of the first terminal device and the D2D chip of the second terminal device. In this way, a multi-link collaborative transmission manner of a Wi-Fi link and a D2D direct communication link may be used between different devices, to implement multi-link accelerated transmission in a local area network.

In some possible implementations, that the D2D chip is configured to establish a second communication link to the second terminal device includes: The D2D chip is configured to establish the second communication link to the second terminal device by using a first interface, where the first interface is an interface used for direct communication between devices.

For example, the first interface is a PC5 interface. The first terminal device may directly communicate with the second terminal device by using the PC5 interface.

In a possible implementation of the first aspect, an operating frequency band of the first communication link is an unlicensed frequency band of 2.4 GHz and/or an unlicensed frequency band of 5 GHz and/or an unlicensed frequency band of 6 GHz; and an operating frequency band of the second communication link is an unlicensed frequency band of 2.4 GHz and/or an unlicensed frequency band of 5 GHz and/or an unlicensed frequency band of 6 GHz.

It should be noted that the first communication link operating on the unlicensed frequency band of 2.4 GHz may be referred to as a 2.4 GHz Wi-Fi link, and the first communication link operating on the unlicensed frequency band of 5 GHz may be referred to as a 5 GHz Wi-Fi link. The second communication link operating on the unlicensed frequency band of 2.4 GHz may be referred to as a 2.4 GHz D2D link, and the second communication link operating on the unlicensed frequency band of 5 GHz may be referred to as a 5 GHz D2D link.

For example, the target data streams may be transmitted between the first terminal device and the second terminal device by using a 2.4 GHz Wi-Fi link and a 2.4 GHz D2D link. Alternatively, the target data streams may be transmitted between the first terminal device and the second terminal device by using a 5 GHz Wi-Fi link and a 2.4 GHz D2D link. Alternatively, the target data streams may be transmitted between the first terminal device and the second terminal device by using a 2.4 GHz Wi-Fi link and a 5 GHz D2D link. Alternatively, the target data streams may be transmitted between the first terminal device and the second terminal device by using a 5 GHz Wi-Fi link and a 5 GHz D2D link.

For example, the target data streams may be transmitted between the first terminal device and the second terminal device by using a 2.4 GHz Wi-Fi link, a 5 GHz Wi-Fi link, and a 2.4 GHz D2D link. Alternatively, the target data streams may be transmitted between the first terminal device and the second terminal device by using a 2.4 GHz Wi-Fi link, a 5 GHz Wi-Fi link, and a 5 GHz D2D link.

For example, the target data streams may be transmitted between the first terminal device and the second terminal device by using a 2.4 GHz Wi-Fi link, a 2.4 GHz D2D link, and a 5 GHz D2D link. Alternatively, the target data streams may be transmitted between the first terminal device and the second terminal device by using a 5 GHz Wi-Fi link, a 2.4 GHz D2D link, and a 5 GHz D2D link.

For example, the target data streams may be transmitted between the first terminal device and the second terminal device by using a 2.4 GHz Wi-Fi link, a 5 GHz Wi-Fi link, a 2.4 GHz D2D link, and a 5 GHz D2D link.

It should be noted that the preset service is a service preset by a system or defined by a user, for example, a service with a high-speed transmission requirement or a service with a low-delay requirement. For example, a bidirectional data transmission service is used as an example. In a scenario in which the user performs real-time touch in a projection image in a projection screen process, a target data stream in the scenario includes a sent projection stream and a received touch stream. In this case, transmission of the touch stream needs to be fast and has a low delay.

In a possible implementation of the first aspect, when the preset service is a bidirectional data transmission service, the target data streams include a first data stream sent by the first terminal device to the second terminal device and a second data stream sent by the second terminal device to the first terminal device.

The Wi-Fi chip is specifically configured to transmit the first data stream to the second terminal device by using the first communication link, and the D2D chip is specifically configured to receive, by using the second communication link, the second data stream transmitted by the second terminal device.

Alternatively, the D2D chip is specifically configured to transmit the first data stream to the second terminal device by using the second communication link, and the Wi-Fi chip is specifically configured to receive, by using the first communication link, the second data stream transmitted by the second terminal device.

In a possible implementation of the first aspect, the first terminal device further includes a display unit. The display unit is configured to display a multi-link icon on a display of the first terminal device, and the multi-link icon indicates that the first terminal device already establishes the first communication link and the second communication link.

Optionally, the second terminal device may also display the multi-link icon, to indicate that the second terminal device already establishes the first communication link and the second communication link.

In a possible implementation of the first aspect, the first terminal device further includes a processing unit. The processing unit is configured to: determine, based on first communication capability information and second communication capability information, a plurality of communication links supported between the first terminal device and the second terminal device; and determine the first communication link and the second communication link from the plurality of communication links based on transmission requirement information of the preset service. The first communication capability information indicates a communication link supported by the first terminal device, and the second communication capability information indicates a communication link supported by the second terminal device.

In a possible implementation of the first aspect, the transmission requirement information of the preset service includes throughput rate requirement information and/or delay requirement information. In this case, the processing unit is specifically configured to: when the throughput rate requirement information indicates that a required throughput rate used to transmit the target data streams is greater than or equal to a preset throughput rate threshold, and/or the delay requirement information indicates that a required delay value used to transmit the target data streams is less than a preset delay threshold, determine the plurality of communication links as the first communication link and the second communication link.

It should be noted that, in a transmission scenario in which a high throughput rate and/or a low delay is preferred, in this embodiment of this application, data transmission may be performed by using a maximum transmission capability of the plurality of links supported by two terminal devices, to ensure a transmission effect of a high throughput rate and/or a low delay.

In a possible implementation of the first aspect, the first terminal device further includes a transceiver unit. The transceiver unit is configured to: discover the second terminal device by using a Bluetooth link; and obtain the second communication capability information from the second terminal device by using the Bluetooth link.

In this way, the terminal device may first discover another terminal device by using Bluetooth, and then negotiate respective transmission capabilities with the another terminal device. If all the terminal devices support multi-link communication, data may be transmitted between the terminal devices by using a plurality of links.

In a possible implementation of the first aspect, the first terminal device further includes the display unit. The display unit is configured to display first prompt information in response to an operation of initiating a target service by a user, where the first prompt information is used to prompt whether to transmit, by using a plurality of links, a target data stream corresponding to the preset service.

The Wi-Fi chip is specifically configured to: in response to a confirmation operation of the user for the first prompt information, establish the first communication link with the second terminal device, and transmit the target data streams between the first terminal device and the second terminal device by using the first communication link.

The D2D chip is specifically configured to: in response to the confirmation operation of the user for the first prompt information, establish the second communication link with the second terminal device, and transmit the target data streams between the first terminal device and the second terminal device by using the second communication link.

In a possible implementation of the first aspect, the Wi-Fi chip is further configured to exchange information with the D2D chip by using a universal asynchronous receiver/transmitter (universal asynchronous receiver/transmitter, UART) interface.

For example, the Wi-Fi chip and the D2D chip of the first terminal device may perform collaborative processing, and may separately perform collaborative processing with the Wi-Fi chip 21 and the D2D chip of the second terminal device, so that four communication links may be established between the first terminal device and the second terminal device: a 2.4 GHz Wi-Fi link, a 5 GHz Wi-Fi link, a 2.4 GHz D2D direct communication link, and a 5 GHz D2D direct communication link. The target data streams may be transmitted between first terminal device and the second terminal device by using at least two of the four communication links. Compared with a conventional solution in which transmission is performed by using a single link, in the solution provided in this embodiment of this application, point-to-point transmission acceleration is implemented through point-to-point multi-link or multi-network collaborative transmission.

In a possible implementation of the first aspect, the Wi-Fi chip is further configured to: when the first terminal device processes a non-preset service, transmit, by using the first communication link, a data stream corresponding to the non-preset service to the second terminal device.

For example, when the first terminal device processes a non-preset service, the first terminal device may communicate with the second terminal device by using a 2.4 GHz Wi-Fi link, or may communicate with the second terminal device by using a 5 GHz Wi-Fi link, or may communicate with the second terminal device by using a 2.4 GHz Wi-Fi link and a 5 GHz Wi-Fi link.

According to a second aspect, this application provides a multi-link communication method, and the method includes:

When a first terminal device processes a preset service, target data streams are transmitted between the first terminal device and a second terminal device by using a first communication link and a second communication link, where
the first communication link includes at least one Wi-Fi link that complies with a Wi-Fi protocol, the second communication link includes at least one D2D link that complies with a D2D sidelink SL protocol, the target data streams are data streams corresponding to the preset service, and the preset service is a unidirectional data transmission service or a bidirectional data transmission service.

In a possible implementation of the second aspect, an interface of the second communication link may be an interface used for direct communication between devices.

In a possible implementation of the second aspect, an operating frequency band of the first communication link is an unlicensed frequency band of 2.4 GHz and/or an unlicensed frequency band of 5 GHz and/or an unlicensed frequency band of 6 GHz; and an operating frequency band of the second communication link is an unlicensed frequency band of 2.4 GHz and/or an unlicensed frequency band of 5 GHz and/or an unlicensed frequency band of 6 GHz.

In a possible implementation of the second aspect, when the preset service is a bidirectional data transmission service, the target data streams include a first data stream sent by the first terminal device to the second terminal device and a second data stream sent by the second terminal device to the first terminal device. In this case, that target data streams are transmitted between the first terminal device and a second terminal device by using a first link and a second link includes:
The first terminal device transmits the first data stream to the second terminal device by using the first communication link, and receives, by using the second communication link, the second data stream transmitted by the second terminal device; or
the first terminal device transmits the first data stream to the second terminal device by using the second communication link, and receives, by using the first communication link, the second data stream transmitted by the second terminal device.

In a possible implementation of the second aspect, the method further includes: The first terminal device displays a multi-link icon on a display, where the multi-link icon indicates that the first terminal device already establishes the first communication link and the second communication link.

In a possible implementation of the second aspect, before the target data streams are transmitted between the first terminal device and the second terminal device by using the first communication link and the second communication link, the method further includes: The first terminal device determines, based on first communication capability information and second communication capability information, a plurality of communication links supported between the first terminal device and the second terminal device; and the first terminal device determines the first communication link and the second communication link from the plurality of communication links based on transmission requirement information of the preset service. The first communication capability information indicates a communication link supported by the first terminal device, and the second communication capability information indicates a communication link supported by the second terminal device.

In a possible implementation of the second aspect, the transmission requirement information of the preset service may include throughput rate requirement information and/or delay requirement information. Correspondingly, that the first terminal device determines the first communication link and the second communication link from the plurality of communication links based on transmission requirement information of the preset service includes:

When the throughput rate requirement information indicates that a required throughput rate used to transmit the target data streams is greater than or equal to a preset throughput rate threshold, and/or the delay requirement information indicates that a required delay value used to transmit the target data streams is less than a preset delay threshold, the first terminal device determines the plurality of communication links as the first communication link and the second communication link.

In a possible implementation of the second aspect, before the first terminal device determines the plurality of communication links supported between the first terminal device and the second terminal device, the method further includes: The first terminal device discovers the second terminal device by using a Bluetooth link; and obtains the second communication capability information from the second terminal device by using the Bluetooth link.

In a possible implementation of the second aspect, before the target data streams are transmitted between the first terminal device and the second terminal device by using the first communication link and the second communication link, the method further includes: The first terminal device displays first prompt information in response to an operation of initiating a preset service by the user, where the first prompt information is used to prompt whether to transmit, by using a plurality of links, a target data stream corresponding to the preset service.

Correspondingly, that target data streams are transmitted between the first terminal device and a second terminal device by using a first communication link and a second communication link includes: The target data streams are transmitted between the first terminal device and the second terminal device by using the first communication link and the second communication link in response to a confirmation operation of the user for the first prompt information.

In a possible implementation of the second aspect, the method further includes: When the first terminal device processes a non-preset service, the first terminal device transmits, by using the first communication link, a data stream corresponding to the non-preset service to the second terminal device.

According to a third aspect, this application provides a multi-link communication apparatus. The apparatus includes a unit configured to perform the method in the second aspect. The apparatus may correspondingly perform the method described in the second aspect. For related descriptions of the unit in the apparatus, refer to the descriptions of the second aspect. For brevity, details are not described herein again.

According to a fourth aspect, this application provides a multi-link communication system. The system includes a first terminal device and a second terminal device.

The first terminal device is configured to: when the first terminal device processes a preset service, establish a first communication link and a second communication link to the second terminal device, and transmit target data streams between the first terminal device and the second terminal device by using the first communication link and the second communication link.

The second terminal device is configured to transmit the target data streams between the first terminal device and the second terminal device by using the first communication link and the second communication link.

The first communication link includes at least one Wi-Fi link that complies with a Wi-Fi protocol, the second communication link includes at least one D2D link that complies with a D2D sidelink SL protocol, the target data streams are data streams corresponding to the preset service, and the preset service is a unidirectional data transmission service or a bidirectional data transmission service.

In a possible implementation of the fourth aspect, the first terminal device is configured to send the target data stream to the second terminal device by using the first communication link and the second communication link, and the second terminal device is configured to receive, by using the first communication link and the second communication link, the target data stream sent by the first terminal device.

In a possible implementation of the fourth aspect, when the preset service is a bidirectional data transmission service, the target data streams include a first data stream sent by the first terminal device to the second terminal device and a second data stream sent by the second terminal device to the first terminal device.

The first terminal device is configured to: send the first data stream to the second terminal device by using the first communication link, and receives, by using the second communication link, the second data stream sent by the second terminal device.

The second terminal device is configured to: send the second data stream to the first terminal device by using the second communication link, and receive, by using the first communication link, the first data stream sent by the second terminal device.

In a possible implementation of the fourth aspect, an operating frequency band of the first communication link is an unlicensed frequency band of 2.4 GHz and/or an unlicensed frequency band of 5 GHz and/or an unlicensed frequency band of 6 GHz; and an operating frequency band of the second communication link is an unlicensed frequency band of 2.4 GHz and/or an unlicensed frequency band of 5 GHz and/or an unlicensed frequency band of 6 GHz.

In a possible implementation of the fourth aspect, the first terminal device is specifically configured to establish the second communication link to the second terminal device by using a first interface, where the first interface is an interface used for direct communication between devices. For example, the first interface is a PC5 interface. The first terminal device may directly communicate with the second terminal device by using the PC5 interface.

In a possible implementation of the fourth aspect, the first terminal device is further configured to display a multi-link icon on a display of the first terminal device, where the multi-link icon indicates that the first terminal device already establishes the first communication link and the second communication link. The second terminal device is further configured to display a multi-link icon on a display of the second terminal device, where the multi-link icon indicates that the second terminal device already establishes the first communication link and the second communication link.

In a possible implementation of the fourth aspect, the first terminal device is further configured to: discover the second terminal device by using a Bluetooth link; and obtain second communication capability information from the second terminal device by using the Bluetooth link.

In a possible implementation of the fourth aspect, when the first terminal device processes a non-preset service, the first terminal device is further configured to transmit, by using the first communication link, a data stream corresponding to the non-preset service to the second terminal device.

According to a fifth aspect, this application provides a chip system. The chip system is configured to read and execute a computer program stored in a memory, to perform the method in the second aspect. The chip system includes a Wi-Fi chip and a D2D chip.

Optionally, the chip system further includes a memory, and the memory is connected to the chip system by using a circuit or a wire.

According to a sixth aspect, this application provides a terminal device. The terminal device includes a chip system, the chip system is coupled to a memory, the memory is configured to store a computer program or instructions, and the chip system is configured to execute the computer program or the instructions stored in the memory, so that the method according to the second aspect is performed.

For example, the chip system is configured to execute the computer program or the instructions stored in the memory, so that the terminal device is enabled to perform the method according to the second aspect.

According to a seventh aspect, this application provides a computer-readable storage medium. The computer-readable storage medium stores a computer program (which may also be referred to as instructions or code) used to implement the method according to the second aspect. For example, when the computer program is executed by a computer, the computer is enabled to perform the method according to the second aspect.

According to an eighth aspect, this application provides a computer program product. The computer program product includes a computer program (which may also be referred to as instructions or code), and when the computer program is executed by a computer, the computer is enabled to implement the method according to the second aspect.

It may be understood that, for beneficial effects of the second aspect to the seventh aspect, refer to related descriptions in the first aspect. Details are not described herein again.

### BRIEF DESCRIPTION OF DRAWINGS

FIG. 1 is a diagram of a system architecture in which devices communicate with each other through different interfaces;

FIG. 2 is a block diagram of hardware of a radio frequency front end implemented in a multi-link communication method according to an embodiment of this application;

FIG. 3 is a schematic diagram of a multi-link transmission scenario to which a multi-link communication method is applied according to an embodiment of this application;

FIG. 4 is a schematic flowchart 1 of a multi-link communication method according to an embodiment of this application;

FIG. 5 is a schematic diagram of a multi-link transmission icon in a multi-link communication method according to an embodiment of this application;

FIG. 6 is a schematic flowchart 2 of a multi-link communication method according to an embodiment of this application;

FIG. 7 is a schematic flowchart 3 of a multi-link communication method according to an embodiment of this application;

FIG. 8A and FIG. 8B are a schematic diagram 1 of an interface to which a multi-link communication method is applied according to an embodiment of this application;

FIG. 9A and FIG. 9B are a schematic diagram 2 of an interface to which a multi-link communication method is applied according to an embodiment of this application;

FIG. 10A and FIG. 10B are a schematic flowchart 4 of a multi-link communication method according to an embodiment of this application;

FIG. 11 is a schematic diagram 3 of an interface to which a multi-link communication method is applied according to a conventional solution;

FIG. 12 is a schematic diagram 3 of an interface to which a multi-link communication method is applied according to an embodiment of this application;

FIG. 13 is a schematic diagram of a structure of a terminal device according to an embodiment of this application; and

FIG. 14 is a schematic diagram of a structure of another terminal device according to an embodiment of this application.

### DESCRIPTION OF EMBODIMENTS

To make the objectives, technical solutions, and advantages of embodiments of this application clearer, the following clearly and completely describes the technical solutions in embodiments of this application with reference to accompanying drawings in embodiments of this application. It is clear that the described embodiments are merely some rather than all of embodiments of this application. All other embodiments obtained by a person of ordinary skill in the art based on embodiments of this application without creative efforts shall fall within the protection scope of this application.

Technical solutions in embodiments of this application may be applied to various communication systems, for example, a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, and a future 5th generation (5th generation, 5G) system or a new radio (new radio, NR) system.

A terminal device in embodiments of this application may include a device that provides voice and/or data connectivity for a user. Specifically, the terminal device includes a device that provides voice for a user, or includes a device that provides data connectivity for a user, or includes a device that provides voice and data connectivity for a user. For example, the terminal device may include a handheld device having a wireless connection function, or a processing device connected to a wireless modem. The terminal device may communicate with a core network device through a radio access network (radio access network, RAN) device, and exchange voice or data with the RAN, or exchange voice and data with the RAN. The terminal device may include user equipment (user equipment, UE), a wireless terminal device, a mobile terminal device, a D2D terminal device, and a vehicle to everything (vehicle to everything, V2X) terminal device, a machine-to-machine/machine-type communication (machine-to-machine/machine-type communication, M2M/MTC) terminal device, an internet of things (internet of things, IoT) terminal device, a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal device may include a mobile phone (or referred to as a “cellular” phone), a computer with a mobile terminal device, a portable, pocket-sized, handheld, or computer built-in mobile apparatus. For example, the terminal device may be a personal communication service (personal communication service, PCS) phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device, another processing device connected to a wireless modem, a vehicle-mounted device, a wearable device, a terminal device in a future 5G network, a terminal device in a future evolved public land mobile network (public land mobile network, PLMN), or the like. This is not limited in the embodiments of this application. In this embodiment of this application, the terminal device may further include a relay (relay). Alternatively, it may be understood that all devices that can perform data communication with the base station may be considered as terminal devices.

In embodiments of this application, an apparatus configured to implement a function of the terminal device may be a terminal device, or may be an apparatus, for example, a chip system, that can support the terminal device in implementing the function. The apparatus may be mounted in the terminal device. In this embodiment of this application, the chip system may include a chip, or may include a chip and another discrete component. In the technical solutions provided in embodiments of this application, an example in which an apparatus configured to implement a function of a terminal is a terminal device is used to describe the technical solutions provided in embodiments of this application.

A network device in this embodiment of this application may be a device that can provide a random access function for a terminal device or a chip that can be disposed in the device. The device includes but is not limited to an evolved NodeB (evolved NodeB, eNB), a radio network controller (radio network controller, RNC), a NodeB (NodeB, NB), a base station controller (base station controller, BSC), a base transceiver station (base transceiver station, BTS), a home NodeB (home evolved NodeB, or home NodeB, HNB), a baseband unit (baseband unit, BBU), an access point (access point, AP) in a wireless fidelity (wireless fidelity, Wi-Fi) system, a wireless relay node, a wireless backhaul node, a transmission point (transmission point, TP) or a transmission and reception point (transmission and reception point, TRP), and the like. Alternatively, the device may be a 5G base station (gNB) or a transmission point (TRP or TP) in a fifth generation (fifth generation, 5G) system, for example, a new radio (new radio, NR) system, or one antenna panel or a group of antenna panels (including a plurality of antenna panels) of a base station in a 5G system. Alternatively, the device may be a network node, for example, a baseband unit (BBU) or a distributed unit (distributed unit, DU), that constitutes a gNB or a transmission point. The 5G base station may include various forms of macro base stations, micro base stations, relay nodes, access points, or the like. In systems that use different radio access technologies, names of devices having functions of the base station may vary.

For ease of understanding embodiments of this application, the following describes a part of terms in embodiments of this application, to help a person skilled in the art have a better understanding.

(1) D2D communication is also referred to as device-to-device communication, means that data may be directly transmitted between different terminal devices without using a network device (for example, a base station), and therefore is also referred to as D2D direct communication. This communication mode is different from a conventional cellular system communication mode. The D2D communication link may be referred to as a D2D direct communication link, a neighbor service link, a secondary link (sidelink, or translated as sidelink, sidelink, sidelink, and the like), or other applicable terms.

The D2D technology has a short link distance and high channel quality, can meet a requirement of an information sharing service between neighboring users, and provides transmission services with high rates, low delay, and low power consumption. An introduction of a D2D heterogeneous network in a cellular network can flexibly expand a network structure and cover a network coverage hole. In addition, cell edge communication quality can be improved by reusing cellular network resources, so that user experience and system capacity can be improved.

In addition, compared with another direct connection technology (for example, Wi-Fi or Bluetooth) that does not depend on infrastructure network facilities, D2D communication is more flexible. Connection and resource allocation may be performed under control of a base station, or information exchange may be performed in a scenario without network infrastructure. Therefore, the D2D communication link can improve a system throughput and provide better user experience.

The D2D communication technology includes a vehicle wireless communication technology (vehicle-to-everything, V2X). The V2X is a technology that connects a vehicle to everything. V represents a vehicle, and X represents any object that interacts information with the vehicle. Currently X mainly includes a vehicle, a person, a traffic roadside infrastructure, and a network. A cellular network-based internet of vehicles communication technology (cellular V2X, C-V2X) is a vehicle wireless communication technology developed based on a cellular network communication technology such as 3G/4G/5G, includes LTE-V2X based on an LTE network and a NR-V2X system of future 5G networks, and is a powerful supplement to dedicated short-range communication technologies.

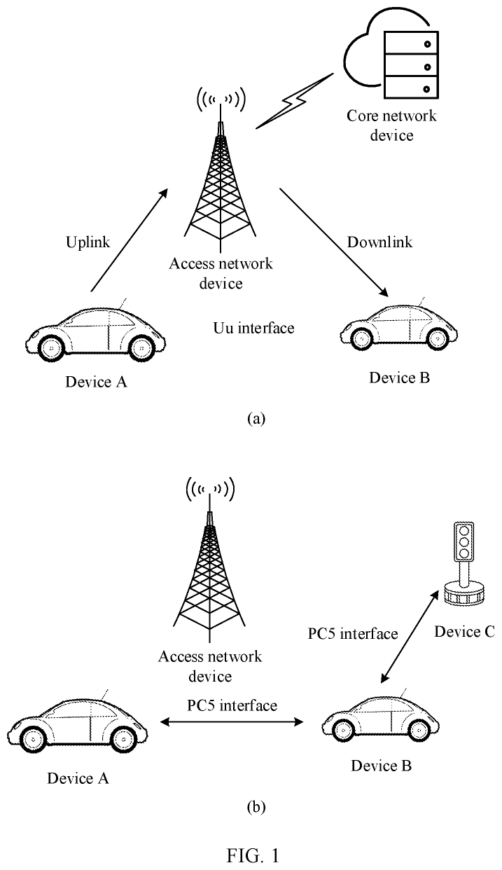

The following uses C-V2X as an example to describe D2D communication. The C-V2X can support work scenarios covered or not covered by cellular networks. In a specific technology, the C-V2X may provide two types of communication interfaces: a Uu interface (cellular communication interface) and a PC5 interface (direct communication interface). As shown in (a) in FIG. 1, a device A and a device B communicate with each other by using an access network device and by using a Uu interface. As shown in (b) in FIG. 1, a device A and a device B directly communicate with each other by using a PC5 interface, and the device B and a device C directly communicate with each other by using a PC5 interface. When a terminal device that supports C-V2X (for example, a vehicle-mounted terminal, a smartphone, or a roadside unit) is covered by a cellular network, the Uu interface can be used under a control of the cellular network. Regardless of whether these terminal devices are covered by a cellular network, these terminal devices may directly communicate with each other by using a PC5 interface. The C-V2X combines the Uu interface and the PC5 interface, so that the two types of interfaces support each other, are used for V2X service transmission, to form effective redundancy to ensure communication reliability. As a core technology of C-V2X, the PC5 interface supports a scheduling-based resource allocation mode and a terminal-autonomous resource allocation mode.

(2) A Wi-Fi dual band dual concurrent (dual band dual concurrent, DBDC) mode supports operating on two frequency bands of 2.4 GHz and 5 GHz simultaneously. In this mode, a terminal device may be connected to Wi-Fi networks of two frequency bands of 2.4 GHz and 5 GHz simultaneously. A device that supports the Wi-Fi dual band dual concurrent mode includes two complete baseband processing modules and two RF front ends, and has two sets of independent channels. Therefore, the device can support two frequency bands of 2.4 GHz and 5 GHz simultaneously. A dual band router may operate in the Wi-Fi dual band dual concurrent mode. For example, the dual band router may operate on two frequency bands of 2.4 GHz and 5 GHz. Dual Wi-Fi acceleration means that a terminal device can connect to Wi-Fi networks of two frequency bands of 2.4 GHz and 5 GHz simultaneously. The frequency bands of 2.4 GHz and 5 GHz under a same router or different routers can be connected and used simultaneously through a dual Wi-Fi acceleration function.

In addition, different from the Wi-Fi dual band dual concurrent mode, a Wi-Fi dual band single concurrent (dual band single concurrent, DBSC) mode supports operating on one frequency band of 2.4 GHz and 5 GHz. In this mode, a terminal device may be connected to a Wi-Fi network of a frequency band of 2.4 GHz, or connected to a Wi-Fi network of a frequency band of 5 GHz. A device that supports the Wi-Fi dual band single concurrent mode includes two complete baseband processing modules and one radio frequency (radio frequency, RF) front end. The RF front end may choose to operate on the frequency band of 2.4 GHz, or may choose to operate on the frequency band of 5 GHz. In the dual band single concurrent mode, the two baseband processing modules support the frequency band of 2.4 GHz and the frequency band of 5 GHz respectively. However, because the RF front end can only select one frequency band to operate on, the dual band single concurrent mode can only achieve single concurrent. Currently, a terminal device may support the Wi-Fi dual band single concurrent mode, that is, may operate on the frequency band of 2.4 GHz or the frequency band of 5 GHz.

Currently, in a point-to-point local area network communication process, a wireless local area network Wi-Fi communication mode is common and universal. For example, in a Huawei Share scenario between mobile phones and a mobile phone cloning scenario, point-to-point data transmission may be implemented by using Wi-Fi. In this case, when a communication environment is poor, for example, interference is strong, a signal is weak, a resource is insufficient, or a load is large, data transmission between terminal devices may be affected, and problems of a low data transmission speed and a long transmission delay occur.

In view of this, an embodiment of this application provides a multi-link communication method. When a device supports D2D communication, a coordinated transmission manner of a Wi-Fi link and a D2D direct communication link may be used, to implement multi-channel acceleration in a local area network and improve stability of a transmission path. Therefore, solutions of this application can resolve problems of a low data transmission speed and a long transmission delay in a current device-to-device communication process. In addition, the multi-link communication method provided in this embodiment of this application may be applied to a short-range point-to-point communication scenario, and data does not need to pass through network devices in a transmission process.

The following first describes specific implementation principles and hardware structure improvements of the solutions provided in embodiments of this application. According to the multi-link communication method provided in this embodiment of this application, point-to-point multi-link communication may be implemented by using a D2D direct communication link and/or a Wi-Fi link. During actual implementation, for a licensed frequency band of 5 GHz (for example, 5855 MHz to 5925 MHz) defined in a current D2D (for example, V2X) communication protocol, in this embodiment of this application, an operating frequency band of D2D communication is moved to or extended to an unlicensed frequency band used by Wi-Fi, such as 2.4 GHz and/or 5 GHz. Therefore, communication capability of a PC5 interface is improved in this embodiment of this application, so that D2D direct communication based on a Wi-Fi frequency band of 2.4 GHz and/or a Wi-Fi frequency band of 5 GHz can be implemented.

Optionally, based on the foregoing concept provided in this embodiment of this application, an improvement solution for a radio frequency (radio frequency, RF) front-end module (front-end module, FEM) may include the following two possible solutions.

Solution 1: An original V2X FEM may be extended to a Wi-Fi frequency band. In this solution, the FEM is reconstructed, and a reconstructed FEM is independent of a Wi-Fi FEM.

Solution 2: An original V2X FEM may be connected to an existing FEM in a Wi-Fi frequency band. In this solution, hardware resource reuse can be implemented, but Wi-Fi resources need to be occupied.

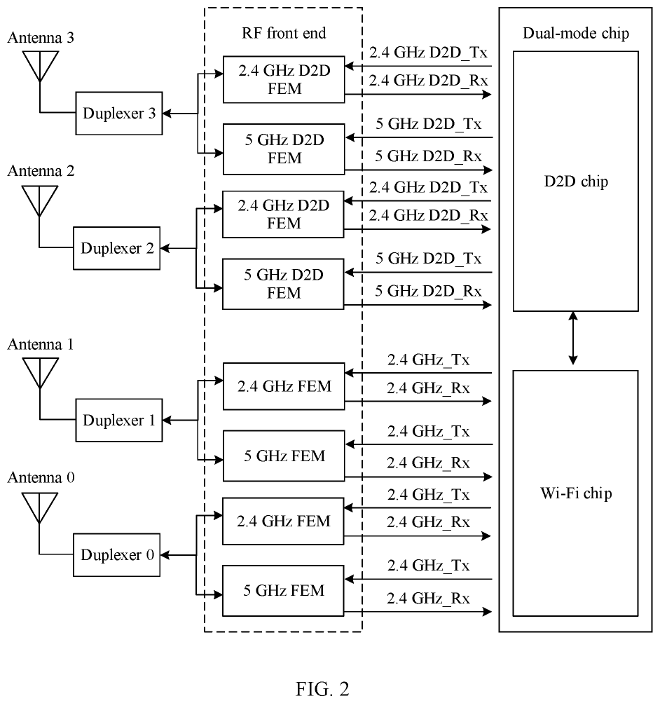

In some embodiments, a C-V2X sidelink protocol procedure in the LTE V2X protocol is applied in combination with an unlicensed spectrum of 2.4 GHz. FIG. 2 is a schematic block diagram of hardware obtained after an RF FEM is improved during actual implementation according to an embodiment of this application. As shown in FIG. 2, in the solution of this application, a short-distance dual-mode chip is used, and a 2.4 GHz front-end circuit is multiplexed, to implement collaboration between a D2D chip and a Wi-Fi chip, to avoid switching overheads caused by additionally adding a radio frequency channel or multiplexing a Wi-Fi channel. In the solution provided in this embodiment of this application, a conventional circuit multiplexing time division solution is improved into a multi-path parallel solution, and point-to-point transmission acceleration is implemented through point-to-point multi-network collaborative transmission.

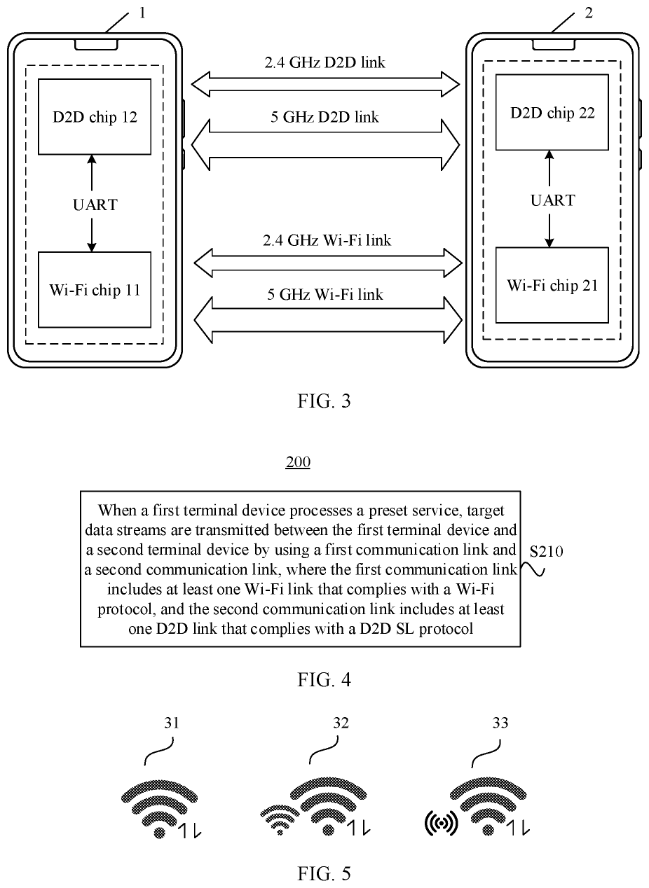

In this embodiment of this application, the D2D chip and the short-distance Wi-Fi/Bluetooth chip are applied in combination, to accelerate transmission within a local area network, and improve stability of a transmission path. FIG. 3 is a schematic diagram of a multi-link communication scenario to which a multi-link communication method is applied according to an embodiment of this application. As shown in FIG. 3, a terminal device 1 includes a Wi-Fi chip 11 (or a modem) and a D2D chip 12 (or a modem). The two chips may be connected by using a UART, and information and a state between the two chips may be transferred in real time by using the UART interface. A terminal device 2 includes a Wi-Fi chip 21 (or a modem) and a D2D chip 22 (or a modem), and the two chips are also connected by using the UART interface. According to the multi-link communication method provided in this embodiment of this application, the terminal device 1 and the terminal device 2 may perform collaborative processing by using the Wi-Fi chip 11, the D2D chip 12, the Wi-Fi chip 21, and the D2D chip 22, and establish four communication links between the terminal device 1 and the terminal device 2: a 2.4 GHz Wi-Fi link, a 5 GHz Wi-Fi link, a 2.4 GHz D2D direct communication link, and a 5 GHz D2D direct communication link. The terminal device 1 may transmit target data streams between the terminal device 1 and the terminal device 2 by using at least two of the four communication links. Compared with a conventional solution in which transmission is performed by using a single link, in the solution provided in this embodiment of this application, point-to-point transmission acceleration is implemented through point-to-point multi-link or multi-network collaborative transmission.

In addition, according to a generalized D2D protocol, an enhanced point-to-point multi-link collaborative communication mechanism may be used in this embodiment of this application, and a transmit/receive (Tx/Rx) path resource may be configured based on communication states of D2D direct communication and Wi-Fi. This configuration process depends on an interface between the D2D chip and the Wi-Fi chip. It should be noted that an interface between the two chips may be a standard UART interface, or may be another non-standard interface, such as a general-purpose input/output port (general-purpose input/output, GPIO), an inter-integrated circuit bus (inter-integrated circuit, I2C), or the like.

It should be noted that the chip that may be used in the multi-link communication method in this embodiment of this application may be two independent chips: a Wi-Fi chip and a D2D chip, or may be a chip that integrates a Wi-Fi chip and a D2D chip. This may be specifically determined based on an actual use requirement. This is not limited in this embodiment of this application.

The following describes in detail features of various aspects and example embodiments of this application. In the following detailed description, many specific details are put forwarded to provide a complete understanding of this application. However, it is clear for a person skilled in the art that this application may be implemented without some of the specific details. The following description of the embodiments is merely intended to provide a better understanding of this application by showing examples of this application. This application is not limited to any specific configuration and algorithm put forwarded in the following, but covers any modification, replacement, and improvement made to elements, components, and algorithms without departing from the spirit of this application. In the following accompanying drawings and descriptions, well-known structures and technologies are omitted, in order not to unnecessarily obscure this application. It should be noted that embodiments in this application and the features in embodiments may be mutually combined in the case of no conflict. This application is described in detail in the following with reference to the accompanying drawings by using embodiments.

The following describes a multi-link communication method 200 according to an embodiment of this application with reference to FIG. 4. The multi-link communication method is applied to a point-to-point communication scenario between terminal devices. As shown in FIG. 4, the method 200 includes the following S210.

S210: When a first terminal device processes a preset service, the first terminal device transmits target data streams between the first terminal device and a second terminal device by using a first communication link and a second communication link, where the first communication link includes at least one Wi-Fi link that complies with a Wi-Fi protocol, and the second communication link includes at least one D2D link that complies with a D2D SL protocol.

The target data stream are data streams corresponding to the preset service, and the preset service is a unidirectional data transmission service or a bidirectional data transmission service.

In this embodiment of this application, it is assumed that the first terminal device and the second terminal device jointly support M communication links, and the M communication links include at least one Wi-Fi link and at least one D2D direct communication link. When the first terminal device processes the preset service, the first terminal device may transmit the target data streams between the first terminal device and the second terminal device by using at least two of the M communication links. In addition, in a process of transmitting the target data stream by using the M communication links, the target data stream may not pass through a cellular network. Terminal devices may directly communicate with each other by using a plurality of communication links, so that data stream transmission can be accelerated through cooperation between a plurality of networks.

Optionally, an operating frequency band of the first communication link is an unlicensed frequency band of 2.4 GHz and/or an unlicensed frequency band of 5 GHz and/or an unlicensed frequency band of 6 GHz; and an operating frequency band of the second communication link is an unlicensed frequency band of 2.4 GHz and/or an unlicensed frequency band of 5 GHz and/or an unlicensed frequency band of 6 GHz. The operating frequency band of the first communication link and the operating frequency band of the second communication link are not specifically limited in this embodiment of this application.

It should be noted that the first communication link operating on the unlicensed frequency band of 2.4 GHz may be referred to as a 2.4 GHz Wi-Fi link, and the first communication link operating on the unlicensed frequency band of 5 GHz may be referred to as a 5 GHz Wi-Fi link. The second communication link operating on the unlicensed frequency band of 2.4 GHz may be referred to as a 2.4 GHz D2D link, and the second communication link operating on the unlicensed frequency band of 5 GHz may be referred to as a 5 GHz D2D link.

For example, the target data streams may be transmitted between the first terminal device and the second terminal device by using a 2.4 GHz Wi-Fi link and a 2.4 GHz D2D link. Alternatively, the target data streams may be transmitted between the first terminal device and the second terminal device by using a 5 GHz Wi-Fi link and a 2.4 GHz D2D link. Alternatively, the target data streams may be transmitted between the first terminal device and the second terminal device by using a 2.4 GHz Wi-Fi link and a 5 GHz D2D link. Alternatively, the target data streams may be transmitted between the first terminal device and the second terminal device by using a 5 GHz Wi-Fi link and a 5 GHz D2D link.

For example, the target data streams may be transmitted between the first terminal device and the second terminal device by using a 2.4 GHz Wi-Fi link, a 5 GHz Wi-Fi link, and a 2.4 GHz D2D link. Alternatively, the target data streams may be transmitted between the first terminal device and the second terminal device by using a 2.4 GHz Wi-Fi link, a 5 GHz Wi-Fi link, and a 5 GHz D2D link.

For example, the target data streams may be transmitted between the first terminal device and the second terminal device by using a 2.4 GHz Wi-Fi link, a 2.4 GHz D2D link, and a 5 GHz D2D link. Alternatively, the target data streams may be transmitted between the first terminal device and the second terminal device by using a 5 GHz Wi-Fi link, a 2.4 GHz D2D link, and a 5 GHz D2D link.

For example, the target data streams may be transmitted between the first terminal device and the second terminal device by using a 2.4 GHz Wi-Fi link, a 5 GHz Wi-Fi link, a 2.4 GHz D2D link, and a 5 GHz D2D link.

It should be noted that an example in which the M communication links include a Wi-Fi link and a D2D direct communication link is used for description herein. During actual implementation, a specific form of the M communication links is not limited in this embodiment of this application. For example, the M communication links may further include a Bluetooth link that operates on an unlicensed frequency band of 2.4 GHz and/or an unlicensed frequency band of 5 GHz, or another near field communication link supported based on an unlicensed frequency band of 2.4 GHz and/or an unlicensed frequency band of 5 GHz. This may be specifically determined based on an actual use requirement. This is not limited in this embodiment of this application.

M is an integer greater than 1. For example, M may be 2, or may be 3, or may be 4, or may be another possible value. This may be specifically determined based on an actual use requirement. This is not limited in this embodiment of this application. For example, M=2. The M communication links may include one Wi-Fi link and one D2D direct communication link. Alternatively, the M communication links may include two Wi-Fi links. Alternatively, the M communication links may include two D2D direct communication links. For another example, M=4. The M communication links may include two Wi-Fi links and two D2D direct communication links. It should be noted that each of the M communication links is corresponding to one operating frequency, and operating frequencies of the links are different from each other.

In some embodiments, the at least one Wi-Fi link includes a 2.4 GHz Wi-Fi link. In some embodiments, the at least one Wi-Fi link includes a 5 GHz Wi-Fi link. In some embodiments, the at least one Wi-Fi link includes a 2.4 GHz Wi-Fi link and a 5 GHz Wi-Fi link. It should be noted that 2.4 GHz and 5 GHz are used as examples for description herein. It may be understood that in actual implementation, the at least one Wi-Fi link in this embodiment of this application may further include a Wi-Fi link of any other possible frequency band (for example, an unlicensed frequency band of 6 GHz). This may be specifically determined based on an actual use requirement. This is not limited in this embodiment of this application.

In some embodiments, the at least one D2D direct communication link includes a 2.4 GHz D2D direct communication link. In some embodiments, the at least one D2D direct communication link includes a 5 GHz D2D direct communication link. In some embodiments, the at least one D2D direct communication link includes a 2.4 GHz D2D direct communication link and a 5 GHz D2D direct communication link. It should be noted that 2.4 GHz and 5 GHz are used as examples for description herein. It may be understood that in actual implementation, the at least one D2D direct communication link in this embodiment of this application may further include a D2D link of any other possible frequency band (for example, an unlicensed frequency band of 6 GHz). This may be specifically determined based on an actual use requirement. This is not limited in this embodiment of this application.

In this embodiment of this application, when the target data streams are transmitted between the first terminal device and the second terminal device by using at least two of the M communication links, specific locations and relative locations of the first terminal device and the second terminal device are not limited in this embodiment of this application. This is not limited in this embodiment of this application. Optionally, both the first terminal device and the second terminal device may be located within coverage of a cellular network, or both may be located outside coverage of a cellular network. Alternatively, the first terminal device is located within coverage of a cellular network, and the second terminal device is located outside coverage of the cellular network. Alternatively, the first terminal device is located outside coverage of a cellular network, and the second terminal device is located within coverage of the cellular network. It should be noted that, when the terminal device is located outside coverage of the cellular network, the terminal device may perform resource scheduling by using a PC5 interface in a terminal-autonomous resource allocation mode. In this case, the terminal device does not interact with the cellular network. When the terminal device is located within coverage of a cellular network, the terminal device may perform resource scheduling by using a PC5 interface in a network scheduling-based resource allocation mode. In this case, the terminal device may interact with the cellular network by using a Uu interface.

In some embodiments, the first terminal device may display first prompt information in response to an operation of initiating an interactive service by a user, where the first prompt information is used to prompt whether to transmit, by using the M communication links, the target data stream corresponding to the interactive service. Further, in response to a confirmation operation of the user for the first prompt information, the target data streams may be transmitted between the first terminal device and the second terminal device by using at least two of the M communication links.

In this embodiment of this application, the target data stream may be a data stream corresponding to the interactive service between the first terminal device and the second terminal device. For example, it is assumed that the interactive service is a file transfer service. When the first terminal device transmits an audio file to the second terminal device, the target data stream may be an audio stream. For another example, it is assumed that the interactive service is a projection service. When the first terminal device sends a projection stream to the second terminal device and the second terminal device returns a control data stream to the first terminal device, the target data stream may include a projection stream and a control data stream. A form of the target data stream is not limited in this embodiment of this application, and may be specifically determined based on an actual situation.

In some embodiments, when the target data streams are transmitted between the first terminal device and the second terminal device by using at least two of the M communication links, the first terminal device displays a multi-link transmission icon on a display. The multi-link transmission icon indicates that the first terminal device already enables a multi-link collaborative transmission manner. As shown in FIG. 5, an icon 31 is an icon displayed on a screen of a mobile phone during single Wi-Fi transmission in the related art, an icon 32 is a multi-link transmission icon displayed on a screen of a mobile phone during dual Wi-Fi transmission in this embodiment of this application, and an icon 33 is a multi-link transmission icon displayed on a screen of a mobile phone during Wi-Fi and D2D direct communication transmission in this embodiment of this application. It should be noted that this embodiment of this application is not limited to the multi-link transmission icon shown in FIG. 5. In actual implementation, the multi-link transmission icon may alternatively have another display form, and may be specifically determined based on an actual use requirement. This is not limited in this embodiment of this application.

According to the multi-link communication method provided in this embodiment of this application, when the terminal device supports Wi-Fi and D2D (for example, V2X) communication, the terminal device may communicate with another terminal device in a multi-link collaborative transmission manner such as a Wi-Fi link and a D2D link, to implement multi-link accelerated transmission in a local area network. This may improve data transmission stability, and increase data transmission rate. In embodiments of this application, device-to-device transmission acceleration is implemented through multi-network and multi-link collaborative transmission, to resolve problems of a low data transmission speed and a long transmission delay in a current device-to-device communication process, and improve user service experience.

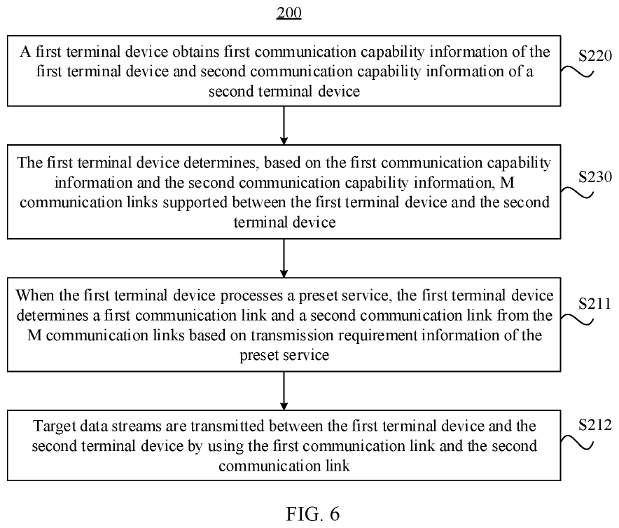

In some possible implementations, with reference to FIG. 4, as shown in FIG. 6, before S210, the method 200 further includes S220 and S230.

S220: The first terminal device obtains first communication capability information of the first terminal device and second communication capability information of the second terminal device.

The first communication capability information indicates a point-to-point communication capability of the first terminal device, that is, indicates point-to-point communication links supported by the first terminal device. For example, the following lists a point-to-point communication capability that the first terminal device may have:
(1) support Wi-Fi dual band single concurrent, for example, a 2.4 GHz Wi-Fi link or a 5 GHz Wi-Fi link;
(2) support Wi-Fi dual band dual concurrent, for example, a 2.4 GHz Wi-Fi link and a 5 GHz Wi-Fi link;
(3) support single band D2D direct communication, for example, a 2.4 GHz D2D direct communication link or a 5 GHz D2D direct communication link;
(4) support dual band D2D direct communication, for example, a 2.4 GHz D2D direct communication link and a 5 GHz D2D direct communication link;
(5) support 2.4 GHz and 5 GHz Wi-Fi dual band single concurrent and single band D2D direct communication;
(6) support 2.4 GHz and 5 GHz Wi-Fi dual band dual concurrent and single band D2D direct communication;
(7) support 2.4 GHz and 5 GHz Wi-Fi dual band single concurrent and dual band D2D direct communication; or
(8) support 2.4 GHz and 5 GHz Wi-Fi dual band dual concurrent and dual band D2D direct communication.

It may be understood that several possible point-to-point communication capabilities are listed herein as examples. Certainly, the first terminal device may further have another point-to-point communication capability, for example, a Bluetooth communication capability or an NFC communication capability. This may be specifically determined based on an actual use requirement. This is not limited in this embodiment of this application.

Similarly, the second communication capability information indicates a point-to-point communication capability of the second terminal device, that is, indicates point-to-point communication links supported by the second terminal device. For details about the point-to-point communication capability of the second terminal device, refer to the foregoing detailed description of the point-to-point communication capability of the first terminal device.

In some embodiments, the first terminal device may discover the second terminal device by using a Bluetooth link, and then obtain the second communication capability information of the second terminal device by using the Bluetooth link. Further, when it is confirmed that both devices support collaborative transmission on a plurality of communication links such as a Wi-Fi link and a D2D direct communication link, the first terminal device performs point-to-point communication with the second terminal device by using the plurality of communication links. In this way, point-to-point transmission acceleration is implemented through point-to-point multi-network collaborative transmission.

The foregoing Bluetooth link may be a channel supported by a Bluetooth low energy (Bluetooth low energy, BLE) technology. Certainly, the Bluetooth link may further be a channel supported by any other possible Bluetooth technology.

Optionally, the first terminal device may further discover the second terminal device by using a Wi-Fi link or a D2D link. Alternatively, the first terminal device may discover the second terminal device in any other possible manner (for example, an NFC link). This may be specifically determined based on an actual use requirement. This is not limited in this embodiment of this application.

S230: The first terminal device determines, based on the first communication capability information and the second communication capability information, M communication links supported between the first terminal device and the second terminal device.

In this embodiment of this application, as described above, different terminal devices have different communication capabilities, and there are a plurality of possible cases of the communication capability of each terminal device. Therefore, before two terminal devices communicate by using a plurality of links, communication capabilities of the two terminal devices need to be negotiated. The plurality of links are established only when it is determined that the two terminal devices can support multi-link communication, and then data stream transmission may be performed by using the plurality of links. For example, the following Table 1 lists several possible communication capability negotiation results.

TABLE 1

| Point-to-point | Point-to-point | |
|---|---|---|
| communication | communication | |
| capability supported by | capability supported by | |
| the first terminal | the second terminal | Communication capability |
| device | device | negotiation result |
| 2.4 GHz/5 GHz | 2.4 GHz/5 GHz | Single link (no multi-link communication |
| Support Wi-Fi dual | Support Wi-Fi dual | capability): |
| band single concurrent | band single concurrent | 2.4 GHz Wi-Fi link or 5 GHz Wi-Fi link |
| 2.4 GHz/5 GHz | 2.4 GHz/5 GHz | Dual Wi-Fi links: |
| Support Wi-Fi dual | Support Wi-Fi dual | 2.4 GHz Wi-Fi link + 5 GHz Wi-Fi link |
| band dual concurrent | band dual concurrent | |
| 2.4 GHz/5 GHz | 2.4 GHz/5 GHz | Dual links: |
| Support Wi-Fi dual | Support Wi-Fi dual | 2.4 GHz Wi-Fi link + 2.4 GHz D2D direct |
| band single concurrent | band single concurrent | communication link |
| Support D2D single | Support D2D single | 5 GHz Wi-Fi link + 2.4 GHz D2D direct |
| band direct connection | band direct connection | communication link |
| | | 2.4 GHz Wi-Fi link + 5 GHz D2D direct |
| | | communication link |
| | | 5 GHz Wi-Fi link + 5 GHz D2D direct |
| | | communication link |
| 2.4 GHz/5 GHZ | 2.4 GHz/5 GHZ | Multiple links (for example, four links): |
| Support Wi-Fi dual | Support Wi-Fi dual | 2.4 GHz Wi-Fi link + 5 GHz Wi-Fi link + |
| band dual concurrent | band dual concurrent | 2.4 GHz D2D direct communication link + 5 |
| Support D2D dual | Support D2D dual | GHz D2D direct communication link |
| band direct connection | band direct connection | |

It should be noted that, when the first terminal device and the second terminal device support 2.4 GHz and 5 GHz Wi-Fi dual band single concurrent, the two devices do not have a multi-link point-to-point communication capability. In this case, a single Wi-Fi link in a conventional solution is usually used to transmit a data stream.

It can be learned from Table 1 that, when both devices have a multi-link point-to-point communication capability, it may be determined that the M communication links supported between the first terminal device and the second terminal device may be dual Wi-Fi links, or may be dual links, three links, or four links formed by Wi-Fi links and D2D direct communication links, or may be dual D2D direct communication links. This may be specifically determined based on an actual use requirement. This is not limited in this embodiment of this application.

It should be noted that Table 1 is an example. This is not limited in this embodiment of this application, and may further include another possible negotiation result. This may be specifically determined based on an actual use requirement. This is not limited in this embodiment of this application.

For example, S230 may include the following possible cases and corresponding implementations.

Case 1: When both the first terminal device and the second terminal device support collaborative transmission on at least two Wi-Fi links, the first terminal device determines that the M communication links include at least two Wi-Fi links.

For example, when both the two devices support 2.4 GHz and 5 GHz Wi-Fi dual band dual concurrent, that is, both the two devices have a multi-link point-to-point communication capability, the following two communication links are supported between the two devices: a 2.4 GHz Wi-Fi link and a 5 GHz Wi-Fi link.

Case 2: When both the first terminal device and the second terminal device support transmission on a single Wi-Fi link and transmission on a single D2D direct communication link, the first terminal device determines that the M communication links include one Wi-Fi link and one D2D direct communication link.

For example, when both devices support 2.4 GHz Wi-Fi communication and 2.4 GHz D2D direct communication, that is, both devices have a multi-link point-to-point communication capability, the following two communication links are supported between the two devices: a 2.4 GHz Wi-Fi link and a 2.4 GHz D2D direct communication link.

For another example, when both devices support 2.4 GHz and 5 GHz Wi-Fi dual band single concurrent and support 2.4 GHz D2D direct communication, that is, both devices have a multi-link point-to-point communication capability, a 2.4 GHz Wi-Fi link and a 2.4 GHz D2D direct communication link are supported between the two devices, or a 5 GHz Wi-Fi link and a 2.4 GHz D2D direct communication link are supported between the two devices.

For another example, when both devices support 2.4 GHz and 5 GHz Wi-Fi dual band single concurrent and 5 GHz D2D direct communication, that is, both devices have a multi-link point-to-point communication capability, the following two communication links are supported between the two devices: a 2.4 GHz Wi-Fi link and a 5 GHz D2D direct communication link, or a 5 GHz Wi-Fi link and a 5 GHz D2D direct communication link. In this case, the 5 GHz Wi-Fi link and the 5 GHz D2D direct communication link are maximum communication capabilities of the two devices.

Case 3: When both the first terminal device and the second terminal device support collaborative transmission on at least two D2D direct communication links, the first terminal device determines that the M communication links include at least two D2D direct communication links.

For example, when the first terminal device and the second terminal device support 2.4 GHz and 5 GHz D2D direct communication collaborative transmission, that is, both devices have a multi-link point-to-point communication capability, the following two communication links may be supported between the two devices: a 2.4 GHz D2D direct communication link and a 5 GHz D2D direct communication link.

Case 4: When both the first terminal device and the second terminal device support collaborative transmission on at least two Wi-Fi links and collaborative transmission on at least two D2D direct communication links, the first terminal device determines that the M communication links include at least two Wi-Fi links and at least two D2D direct communication links.

For example, when the first terminal device and the second terminal device support 2.4 GHz and 5 GHz Wi-Fi dual band dual concurrent and 2.4 GHz and 5 GHz D2D direct communication collaborative transmission, that is, both the two devices have a multi-link point-to-point communication capability, the following four communication links may be supported between the two devices: a 2.4 GHz Wi-Fi link, a 5 GHz Wi-Fi link, a 2.4 GHz D2D direct communication link, and a 5 GHz D2D direct communication link.

It should be noted that a D2D link may be extended to an unlicensed frequency band of 2.4/5 GHz of Wi-Fi to implement direct communication between devices, or may be extended to an unlicensed frequency band of 6 GHz of Wi-Fi to implement direct communication between devices, or may be extended to any other unlicensed frequency band of Wi-Fi that meets an actual use requirement to implement direct communication between devices. This may be specifically determined based on an actual use requirement. This is not limited in this embodiment of this application.

As shown in FIG. 6, based on S220 and S230, S210 may specifically include the following steps S211 and S212.

S211: When the first terminal device processes the preset service, the first terminal device determines the first communication link and the second communication link from the M communication links based on transmission requirement information of the preset service.

S212: The target data streams are transmitted between first terminal device and the second terminal device by using the first communication link and the second communication link.

The transmission requirement information may include at least one of throughput rate requirement information, delay requirement information, and energy consumption requirement information. The throughput rate requirement information indicates whether a required throughput rate used to transmit the target data streams is greater than or equal to a preset throughput rate threshold. The delay requirement information indicates whether a required delay value used to transmit the target data streams is less than a preset delay threshold. The energy consumption requirement information indicates whether required energy consumption of the terminal device when the terminal device transmits the target data streams is less than a preset energy consumption threshold. It should be noted that the transmission requirement information may further include any other information that meets an actual use requirement. This may be specifically determined based on an actual use requirement. This is not limited in this embodiment of this application.

In this embodiment of this application, after determining that both devices support collaborative transmission on the M links, the first terminal device may determine, from the M communication links based on the transmission requirement information corresponding to the target data stream, at least two communication links as links used to transmit the target data stream. All communication links may be selected to transmit the target data stream, or a part of communication links may be selected to transmit the target data stream. This may be specifically determined based on transmission requirement information corresponding to the target data stream.

In some embodiments, that the first terminal device determines the first communication link and the second communication link from the M communication links based on the transmission requirement information of the preset service may include the following possible implementations.

Implementation 1: When the throughput rate requirement information indicates that the required throughput rate used to transmit the target data streams is greater than or equal to the preset throughput rate threshold, a large throughput rate needs to be preferentially considered in this communication scenario, and the first terminal device may use all supported maximum M communication links to transmit the target data stream. That is, in a scenario in which a large throughput rate is required, a maximum communication capability may be selected for data stream transmission, to increase a data transmission volume.

Implementation 2: When the delay requirement information indicates that the required delay value used to transmit the target data streams is less than the preset delay threshold, a low delay needs to be preferentially considered in this communication scenario, and the first terminal device may use all supported maximum M communication links to transmit the target data stream. That is, in a scenario in which a low transmission delay is required, a maximum communication capability may be selected for data stream transmission, to achieve an objective of reducing a transmission delay.

Implementation 3: When the throughput rate requirement information indicates that the required throughput rate used to transmit the target data streams is greater than or equal to the preset throughput rate threshold, and the delay requirement information indicates that the required delay value used to transmit the target data streams is less than the preset delay threshold, a large throughput rate and a low delay need to be preferentially considered in this communication scenario, and the first terminal device may use all supported maximum M communication links to transmit the target data stream, and select a maximum communication capability to transmit the data stream, to improve the transmission rate and reduce the transmission delay.

In this embodiment of this application, an optimal communication link suitable for a current scenario may be automatically selected from a plurality of supported links based on a throughput-first scenario or a delay-first scenario.

The foregoing describes a specific implementation in which the first terminal device determines the at least two communication links from the M communication links. The following describes in detail, by using a first embodiment, a specific implementation in which the first terminal device transmits a unidirectional data stream by using a plurality of links.

In a first embodiment, a scenario in which the target data stream is a unidirectional data stream is mainly discussed. For example, the step of transmitting the target data streams between the first terminal device and the second terminal device by using at least two of the M communication links (the foregoing S210) may include the following several specific implementations.

Implementation 1: The first terminal device may send the target data stream to the second terminal device by using at least two of the M communication links. In this way, point-to-point transmission acceleration is implemented through point-to-point multi-network collaborative transmission.

Implementation 2: The first terminal device may receive, by using at least two of the M communication links, the target data stream sent by the second terminal device. In this way, point-to-point transmission acceleration is implemented through point-to-point multi-network collaborative transmission.

The following describes an implementation process of the first embodiment in embodiments of this application with reference to a specific point-to-point communication scenario.

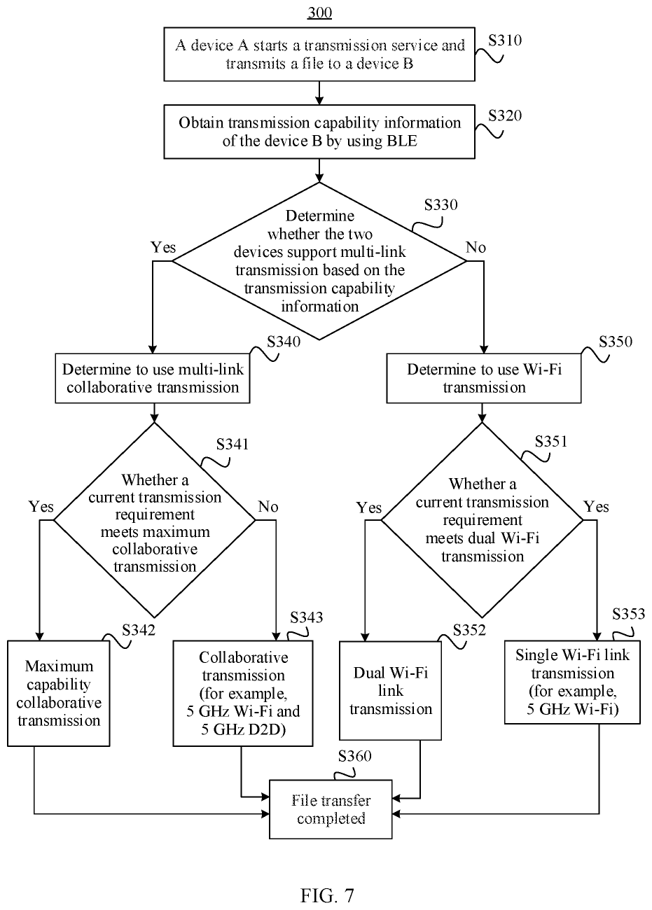

For example, the point-to-point communication scenario is file transfer. FIG. 7 is a flowchart 300 of a multi-link communication method applied to a file transfer scenario according to an embodiment of this application. As shown in FIG. 7, the flowchart 300 includes the following S310 to S360.

S310: A device A starts a file transfer service with a device B.

The device A may start the point-to-point file transfer service with the device B in response to a trigger operation of a user.

S320: The device A obtains transmission capability information of the device B by using BLE.

The device A discovers the device B by using a BLE Bluetooth link, and negotiates with the device B transmission capabilities of both the device A and the device B.

S330: The device A determines, based on transmission capability information of the two devices, whether the device A and the device B support Wi-Fi and D2D collaborative transmission.

If the device A and the device B support Wi-Fi and D2D direct communication collaborative transmission, the device A continues to perform the following S340. Alternatively, if either of the device A and the device B does not support Wi-Fi and D2D direct communication collaborative transmission, the device A continues to perform the following S350.

S340: The device A determines to use a Wi-Fi and D2D collaborative transmission manner.

S341: The device A determines whether a current transmission requirement meets maximum collaborative transmission.

If a required throughput rate corresponding to the file transfer service is greater than or equal to a preset throughput rate threshold, a large throughput rate needs to be preferentially considered, and it may be determined that a data stream corresponding to the file transfer service needs to be collaboratively transmitted by using a maximum capability, to ensure the large throughput rate. If the requirement of the file transfer service meets the maximum collaborative transmission, the following S342 continues to be performed. Alternatively, if the file transfer service does not need to be collaboratively transmitted by using the maximum capability, the following S343 continues to be performed.

S342: The device A performs collaborative transmission by using the maximum capability.

If the maximum capability of the two devices is collaborative transmission on four links, the transmission acceleration on four links is started. For example, the four links may include a 2.4 GHz Wi-Fi link, a 5 GHz Wi-Fi link, a 2.4 GHz D2D direct communication link, and a 5 GHz D2D direct communication link.

S343: The device A performs another multi-link collaborative transmission.

For example, the device A performs collaborative transmission by using links such as a 5 GHz Wi-Fi link and a 5 GHz D2D direct communication link. Alternatively, the device A performs collaborative transmission by using links such as a 2.4 GHz Wi-Fi link, a 5 GHz Wi-Fi link, and a 5 GHz D2D direct communication link. A specific link used by the device A for collaborative transmission may be comprehensively considered and determined based on a transmission requirement. This is not limited in this embodiment of this application. For example, a larger throughput rate requirement indicates a larger number of links, and a smaller number of links may be selected for low power consumption.

S350: The device A determines to use a Wi-Fi transmission manner.

S351: The device A determines whether a requirement of the file transfer service meets dual Wi-Fi transmission.

If the requirement of the file transfer service meets the dual Wi-Fi transmission, the following S352 continues to be performed. Alternatively, if the requirement of the file transfer service does not meet the dual Wi-Fi transmission, the following S353 continues to be performed.

S352: The device A performs collaborative transmission by using dual Wi-Fi links.

For example, the device A transmits file data to the device B by using a 2.4 GHz Wi-Fi link and a 5 GHz Wi-Fi link.

S353: The device A performs transmission by using a single Wi-Fi link.

For example, the device A may transmit file data to the device B by using a 5 GHz Wi-Fi link.

S360: The file transfer service of the device A to the device B is completed.

In the multi-link communication method provided in this embodiment of this application, a D2D direct communication network and a Wi-Fi network are converged to implement multi-network chip-level collaborative transmission between different communication standards. The multi-link communication method may be applied to user experience-sensitive scenarios, such as a station (station, STA)-access point (access point, AP) multi-network acceleration scenario, a Huawei Share OneHop scenario, and a Huawei Share scenario, to improve a throughput rate. The following Table 2 shows a comparison of throughput rates of transmission by using Wi-Fi in a conventional solution and multi-link transmission in a solution of this application in various application scenarios. It can be learned from Table 2 that a throughput rate of transmission by using Wi-Fi in the conventional solution is usually 160 megabits per second (MBps), and a throughput rate of multi-link transmission in the solution of this application may reach more than 200 MBps. Compared with the throughput rate of transmission by using Wi-Fi in the conventional solution, the throughput rate of multi-link transmission is greatly improved. The throughput rate of multi-link transmission depends on a maximum rate of D2D direct communication. For example, if a Wi-Fi throughput rate is about 160 MBps, and a maximum rate of D2D direct communication is 80 MBps, a throughput rate of collaborative transmission by using the Wi-Fi link and the D2D direct communication link may reach 240 MBps.

TABLE 2

| Applicable | Single-link transmission | Multi-link transmission in the |
|---|---|---|
| scenarios | in conventional solution | solution of this application |
| STA & AP | Wi-Fi throughput rate is | Throughput rate is greater |
| | about 160 MBps | than 200 MBps |
| Huawei Share | Wi-Fi throughput rate is | Throughput rate is greater |
| | about 160 MBps | than 200 MBps |
| Huawei Share | Wi-Fi throughput rate is | Throughput rate is greater |
| OneHop | about 120 MBps | than 100 MBps |

In this embodiment of this application, in a wireless local area network environment, a Wi-Fi link may be used as a primary link, and a D2D direct communication link may be used as a secondary link, to implement multi-link accelerated transmission, so that a network speed can be multiplied, stability of data transmission is improved, and a network delay is greatly reduced.

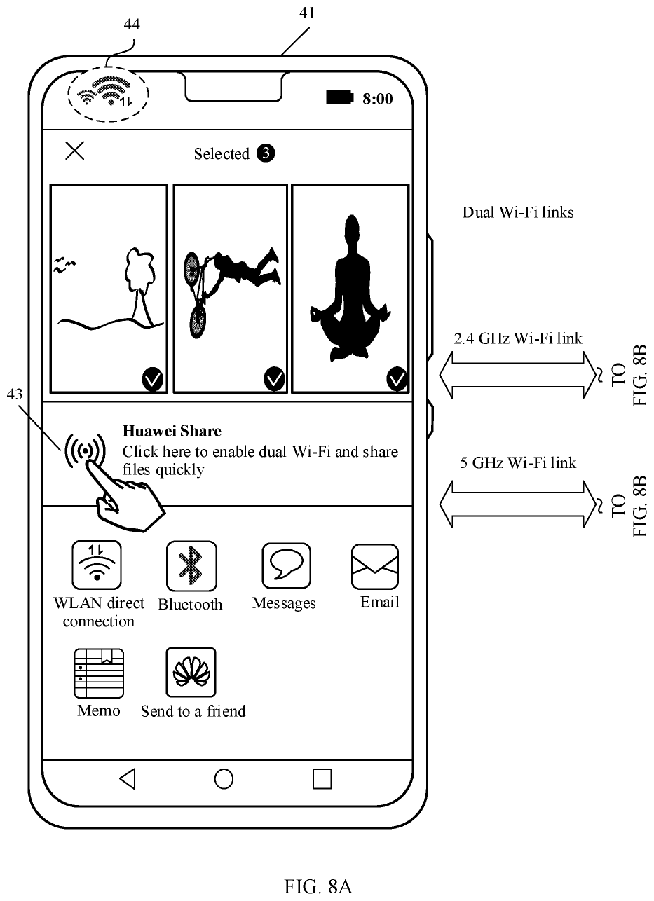

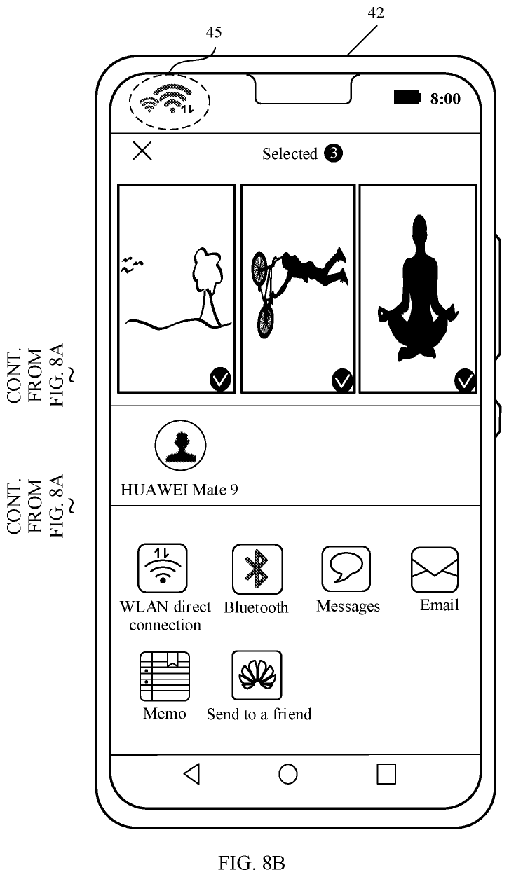

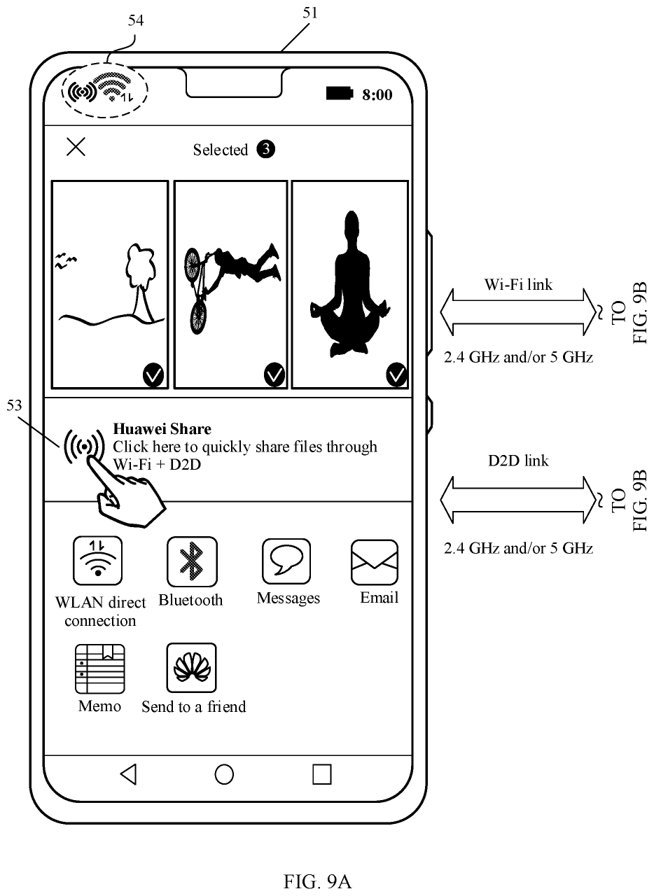

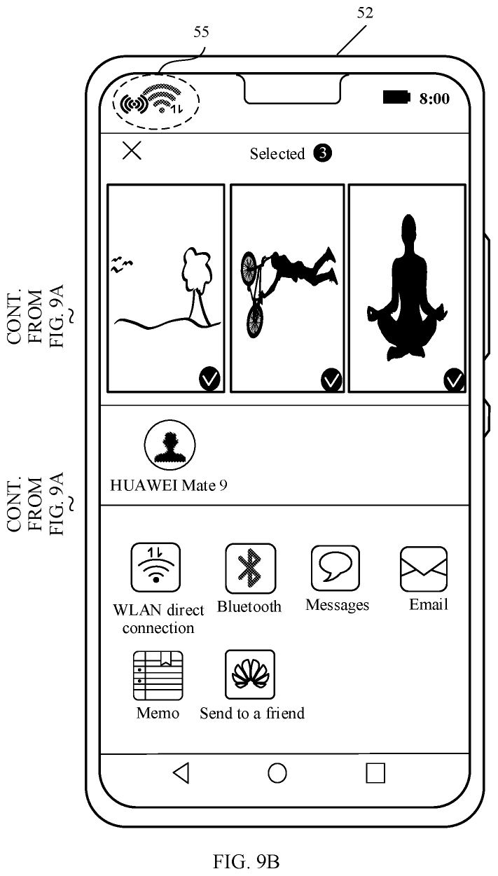

The following schematically describes an implementation process of the first embodiment of embodiments of this application with reference to FIG. 8A and FIG. 8B and FIG. 9A and FIG. 9B.

FIG. 8A and FIG. 8B are a schematic diagram of an interface to which a multi-link communication method is applied according to an embodiment of this application. FIG. 8A and FIG. 8B are a schematic diagram of an interface in which a mobile phone 41 transmits a picture to a mobile phone 42 by using a Huawei Share function. It is assumed that both the mobile phone 41 and the mobile phone 42 support multi-link collaborative transmission, for example, a dual Wi-Fi function. The mobile phone 41 may enable a dual Wi-Fi function in response to a trigger operation of a user on an icon 43 in a Huawei Share interface, and further establish dual Wi-Fi links between the mobile phone 41 and the mobile phone 42: a 2.4 GHz Wi-Fi link and a 5 GHz Wi-Fi link. In this way, the mobile phone 41 may transmit the picture to the mobile phone 42 by using the dual Wi-Fi links, to implement quick file sharing. In the multi-link transmission process, a multi-link transmission icon 44 is displayed on a screen of the mobile phone 41, and a multi-link transmission icon 45 is displayed on a screen of the mobile phone 42 (alternatively, the multi-link transmission icon 45 may not be displayed on the screen of the mobile phone 42). In this way, point-to-point transmission acceleration is implemented through multi-link collaborative transmission.

It should be noted that the dual Wi-Fi links are a dual band working mode. A dual band wireless router may simultaneously generate two independent wireless networks, respectively corresponding to a frequency band of 2.4 GHz and a frequency band of 5 GHz. The two independent wireless networks may use different service set identifiers (service set identifier, SSID), or use a same SSID. The two wireless networks run independently, so the two wireless networks can be executed concurrently. Therefore, a terminal device is connected to two Wi-Fi networks simultaneously, and may transmit data to another terminal device by using two Wi-Fi links, to implement dual Wi-Fi network acceleration.

According to the multi-link communication method provided in this embodiment of this application, the terminal device may be connected to two Wi-Fi networks simultaneously to receive data. This greatly improves a data transmission speed between terminal devices. FIG. 9A and FIG. 9B are a schematic diagram of an interface to which a multi-link communication method is applied according to an embodiment of this application. FIG. 9A and FIG. 9B are a schematic diagram of an interface in which a mobile phone 51 transmits a picture to a mobile phone 52 by using a Huawei Share function. It is assumed that both the mobile phone 51 and the mobile phone 52 support multi-link collaborative transmission. The mobile phone 51 may enable a multi-link collaborative transmission function in response to a trigger operation of a user on an icon 53 in a Huawei Share interface, and establish Wi-Fi and D2D direct communication links between the mobile phone 51 and the mobile phone 52, for example, a 5 GHz Wi-Fi link and a 5 GHz D2D direct communication link. In this way, the mobile phone 51 may transmit the picture to the mobile phone 52 by using a plurality of links, to implement quick file sharing. In the multi-link transmission process, a multi-link transmission icon 54 is displayed on a screen of the mobile phone 51, and a multi-link transmission icon 55 is displayed on a screen of the mobile phone 51. In this way, point-to-point transmission acceleration is implemented through multi-link collaborative transmission.

The foregoing describes in detail a specific implementation of how the first terminal device transmits a unidirectional data stream by using a plurality of links by using the first embodiment. The following describes in detail a specific implementation of how the first terminal device transmits a bidirectional data stream by using a plurality of links by using a second embodiment.

In the second embodiment, a scenario in which a target data stream is a bidirectional data stream is mainly discussed. The target data stream may include a first data stream sent by a first terminal device to a second terminal device and a second data stream sent by the second terminal device to the first terminal device. Correspondingly, M communication links include a first link used to transmit the first data stream and a second link used to transmit the second data stream. That is, in a process in which the first terminal device transmits the first data stream to the second terminal device by using the first link, the second terminal device may transmit the second data stream to the first terminal device by using the second link. In this way, point-to-point bidirectional transmission acceleration is implemented through multi-link collaborative transmission.

For example, the step of transmitting the target data streams between the first terminal device and the second terminal device by using at least two of the M communication links (the foregoing S210) may include the following several specific implementations.

Implementation 1: The first link includes at least one Wi-Fi link, and the second link includes at least one D2D direct communication link.

For example, the first terminal device may transmit the first data stream to the second terminal device by using a 5 GHz Wi-Fi link. In this process, the second terminal device may transmit the second data stream to the first terminal device by using a 5 GHz D2D direct communication link. In this way, point-to-point bidirectional transmission acceleration is implemented through multi-link collaborative transmission.

Implementation 2: The first link includes at least one D2D direct communication link, and the second link includes at least one Wi-Fi link.

For example, the first terminal device may transmit the first data stream to the second terminal device by using a 5 GHz D2D direct communication link. In this process, the second terminal device may transmit the second data stream to the first terminal device by using a 5 GHz Wi-Fi link. In this way, point-to-point bidirectional transmission acceleration is implemented through multi-link collaborative transmission.

Implementation 3: The first link includes a first Wi-Fi link, and the second link includes a second Wi-Fi link whose operating frequency is different from that of the first Wi-Fi link.

For example, the first terminal device may transmit the first data stream to the second terminal device by using a 5 GHz Wi-Fi link. In this process, the second terminal device may transmit the second data stream to the first terminal device by using a 2.4 GHz Wi-Fi link. In this way, point-to-point bidirectional transmission acceleration is implemented through collaborative transmission of a plurality of Wi-Fi links.

Implementation 4: The first link includes a first D2D direct communication link, and the second link includes a second D2D direct communication link whose operating frequency is different from that of the first D2D direct communication link.

For example, the first terminal device may transmit the first data stream to the second terminal device by using a 5 GHz D2D direct communication link. In this process, the second terminal device may transmit the second data stream to the first terminal device by using a 2.4 GHz D2D direct communication link. In this way, point-to-point bidirectional transmission acceleration is implemented through collaborative transmission of a plurality of D2D direct communication links.

Implementation 5: The first link includes a third Wi-Fi link and a third D2D direct communication link, and the second link includes a fourth Wi-Fi link whose operating frequency is different from that of the third Wi-Fi link and a fourth D2D direct communication link whose operating frequency is different from that of the third D2D direct communication link.

For example, the first terminal device may transmit the first data stream to the second terminal device by using a 5 GHz Wi-Fi link and a 5 GHz D2D direct communication link. In this process, the second terminal device may transmit the second data stream to the first terminal device by using a 2.4 GHz Wi-Fi link and a 2.4 GHz D2D direct communication link. In this way, point-to-point bidirectional transmission acceleration is implemented through multi-link collaborative transmission.

In the second embodiment, there is bidirectional transmission of large and small streams in a projection scenario (for example, an amount of data of the first data stream is greater than an amount of data of the second data stream). For example, in a process in which the device A projects a screen onto the device B, the device B may return a control data stream to the device A in response to a control operation of a user, so that the device A receives the control data stream and performs data processing, and further uses processed data as a projection stream and continues to send the projection stream to the device B for projection. This scenario is a low-delay scenario, and real-time projection is ensured.

It should be noted that, when the amount of data of the first data stream is greater than the amount of data of the second data stream, a transmission capability of the first link used to transmit the first data stream is better than a transmission capability of the second link used to transmit the second data stream.

The following describes an implementation process of the second embodiment in embodiments of this application with reference to a specific point-to-point communication scenario.

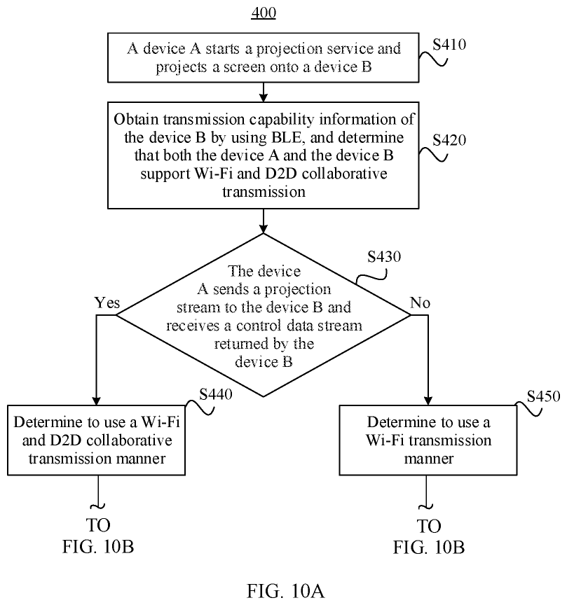

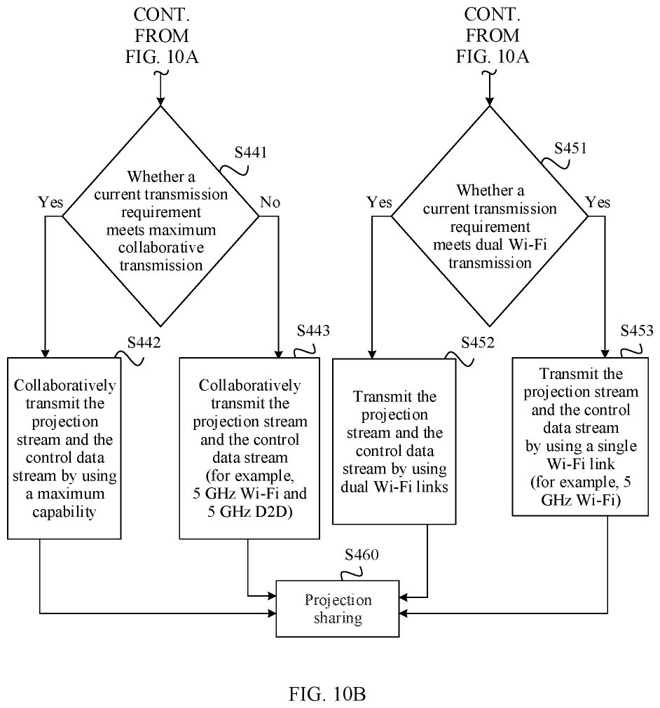

For example, the point-to-point communication scenario is file transfer. FIG. 10A and FIG. 10B are a flowchart 400 of a multi-link communication method applied to a projection interaction scenario according to an embodiment of this application. As shown in FIG. 10A and FIG. 10B, the flowchart 400 includes the following S410 to S460.

S410: A device A starts a projection service.

The device A may start the projection service with a device B in response to a trigger operation of a user. That is, the device A is in a projection mode.

S420: The device A obtains transmission capability information of the device B by using BLE, and determines that the device A and the device B support Wi-Fi and D2D direct communication collaborative transmission.

The device A discovers the device B by using a BLE Bluetooth link, negotiates with the device B transmission capabilities of both the device A and the device B, and determines, based on transmission capability information of both devices, whether the device A and the device B support Wi-Fi and D2D collaborative transmission.

S430: The device A detects whether a control data stream returned by the device B is received when a projection stream is sent to the device B.

If the device A receives, when sending the projection stream to the device B, the control data stream returned by the device B, the device A continues to perform the following S440. Alternatively, if the device A does not receive, when sending the projection stream to the device B, the control data stream returned by the device B, the device A continues to perform S450.

S440: The device A determines to use a Wi-Fi and D2D collaborative transmission manner.

S441: The device A determines whether a current transmission requirement meets maximum collaborative transmission.

For example, if a required transmission throughput rate is greater than or equal to a preset throughput threshold, a large throughput needs to be preferentially considered, and it may be determined that the to-be-transmitted data stream needs to be collaboratively transmitted by using a maximum capability, to ensure transmission at the large throughput rate. If the current transmission requirement meets the maximum collaborative transmission, the following S442 continues to be performed. Alternatively, if the current transmission requirement does not meet the maximum capability collaborative transmission, the following S443 continues to be performed.

S442: The device A performs collaborative transmission by using the maximum capability.

If the maximum capability of the two devices is collaborative transmission on four links, the transmission acceleration on four links is started. For example, the four links may include a 2.4 GHz Wi-Fi link, a 5 GHz Wi-Fi link, a 2.4 GHz D2D direct communication link, and a 5 GHz D2D direct communication link. For example, the device A transmits the projection stream to the device B by using the 5 GHz Wi-Fi link and the 5 GHz D2D direct communication link, and the device B transmits the control data stream to the device A by using the 2.4 GHz Wi-Fi link and the 2.4 GHz D2D direct communication link.

S443: The device A performs collaborative transmission by using other links.

For example, the device A transmits the projection stream to the device B by using a 5 GHz Wi-Fi link, and the device B transmits the control data stream to the device A by using a 5 GHz D2D direct communication link. A specific link used by the device A for collaborative transmission may be comprehensively considered and determined based on a transmission requirement. This is not limited in this embodiment of this application. For example, a larger throughput rate requirement indicates a larger number of links, and a smaller number of links may be selected to ensure low power consumption.

S450: The device A determines to use a Wi-Fi transmission manner.

S451: The device A determines whether a current transmission requirement meets dual Wi-Fi transmission.

If the current transmission requirement meets the dual Wi-Fi transmission, the following S452 continues to be performed. Alternatively, if the current transmission requirement does not meet the dual Wi-Fi transmission, the following S453 continues to be performed.

S452: The device A performs collaborative transmission by using dual Wi-Fi links.

For example, the device A transmits the projection stream to the device B by using a 5 GHz Wi-Fi link, and the device B transmits the control data stream to the device A by using a 2.4 GHz Wi-Fi link.

S453: The device A performs transmission by using a single Wi-Fi link.

For example, the device A transmits file data by using a 5 GHz Wi-Fi link.

S460: Projection interaction is performed between the device A and the device B.

In the multi-link communication method provided in this embodiment of this application, a D2D direct communication network and a Wi-Fi network are converged to implement multi-network chip-level collaborative transmission between different communication standards. In this embodiment of this application, multi-link accelerated transmission is implemented, so that a network speed can be multiplied, stability of data transmission is improved, and a network delay is greatly reduced.

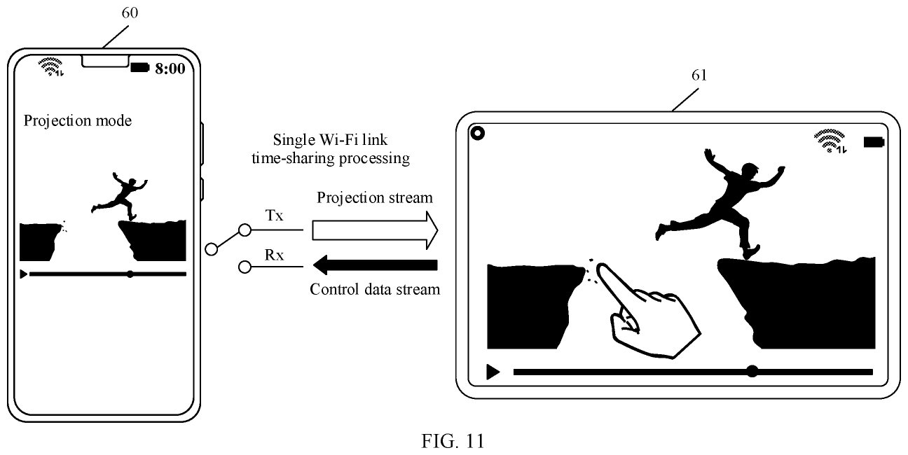

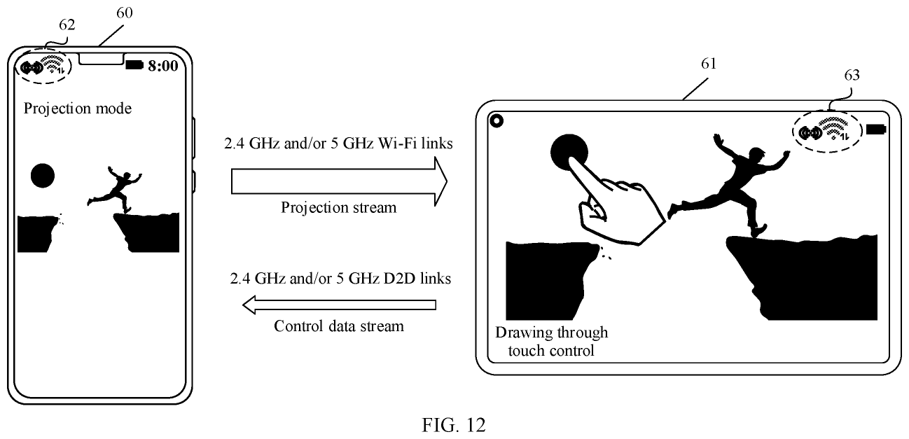

The following schematically describes an implementation process of the second embodiment of embodiments of this application with reference to FIG. 11 and FIG. 12.

FIG. 11 is a schematic diagram of an interface when a conventional solution is applied to a projection scenario. As shown in FIG. 11, a mobile phone 60 sends a projection stream to a tablet computer 61, and correspondingly, the tablet computer 61 displays a projection image. It is assumed that in the projection scenario, the tablet computer 61 receives a control operation (for example, an editing operation, such as drawing) performed by a user on the projection image. The tablet computer 61 returns a control data stream to the mobile phone 60, and the mobile phone 60 processes the current projection image based on the control data stream. In the conventional solution, the projection stream and the control data stream are transmitted by using a single Wi-Fi link, and this single-link transmission manner requires time-sharing processing. For example, the mobile phone 60 first sends the projection stream to the tablet computer 61 by using a 5 GHz Wi-Fi link through a transmit port (Tx), and then receives, by using the 5 GHz Wi-Fi link through a receive port (Rx), the control data stream sent by the tablet computer 61. Therefore, the transmission of the control data stream is delayed, and frame freezing occurs on the projection image.

FIG. 12 is a schematic diagram of an interface when a solution according to an embodiment of this application is applied to a projection scenario. As shown in FIG. 12, in a process in which a mobile phone 60 sends a projection stream to a tablet computer 61, when the tablet computer 61 receives a control operation (for example, drawing) performed by a user on a projection image, the tablet computer 61 returns a control data stream to the mobile phone 60, and the mobile phone 60 processes the current projection image based on the control data stream. In the solution of this application, the projection stream and the control data stream may be transmitted through a plurality of links. For example, the mobile phone 60 transmits the projection stream to the tablet computer 61 by using a 5 GHz Wi-Fi link, and the tablet computer 61 transmits the control data stream to the mobile phone 60 by using a 5 GHz D2D direct communication link. In this way, transmission of the projection stream and transmission of the control data stream may be concurrently executed. In the multi-link transmission process, a multi-link transmission icon 62 is displayed on a screen of the mobile phone 60, and a multi-link transmission icon 63 is displayed on a screen of the tablet computer 61. In actual implementation, in a related technology, the control data stream is usually 20 milliseconds (ms) or more. In this application, a delay of the control data stream can be less than 10 ms by using the multi-link communication method. Therefore, in this application, point-to-point transmission acceleration is implemented through multi-network collaborative transmission, so that stability of data transmission is improved, and a network delay is greatly reduced.

It should be noted that D2D communication in this embodiment of this application is not limited to communication between terminal devices such as mobile phones, and is further applicable to machine-to-machine (machine-to-machine, M2M) communication. The terminal device in embodiments of this application may alternatively refer to various intelligent electrical appliances, such as an automobile, a bus, a printer, a copier, or a refrigerator.

It should be noted that, in embodiments of this application, “greater than” may be replaced with “greater than or equal to”, and “less than or equal to” may be replaced with “less than”, or “greater than or equal to” may be replaced with “greater than”, and “less than” may be replaced with “less than or equal to”.

Embodiments described in this specification may be independent solutions, or may be combined based on internal logic. All these solutions fall within the protection scope of this application.

It may be understood that in the foregoing method embodiments, the methods and operations implemented by the network device may alternatively be implemented by a component (for example, a chip or a circuit) that can be used in the network device. In the foregoing method embodiments, the methods and operations implemented by the terminal device may alternatively be implemented by a component (for example, a chip or a circuit) that can be used in the terminal device. In the foregoing method embodiments, the methods and operations implemented by the core network device may alternatively be implemented by a component (for example, a chip or a circuit) that can be used in the core network device.

The foregoing describes method embodiments provided in this application, and the following describes apparatus embodiments provided in this application. It should be understood that descriptions of apparatus embodiments correspond to the descriptions of the method embodiments. Therefore, for content that is not described in detail, refer to the foregoing method embodiments. For brevity, details are not described herein again.

The foregoing mainly describes the solutions provided in embodiments of this application from the perspective of interaction between devices. It may be understood that, to implement the foregoing functions, each device, such as a transmit-end device or a receive-end device, includes a corresponding hardware structure and/or software module for performing each function. A person skilled in the art should be able to be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the protection scope of this application.

In embodiments of this application, the transmit end device or the receive end device may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that, in embodiments of this application, division into the modules is an example, and is merely logical function division. During actual implementation, another division manner may be used. An example in which each function module is obtained through division based on each corresponding function is used below for description.

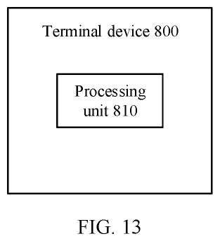

An embodiment of this application provides a terminal device. The terminal device may be configured to perform actions performed by the first terminal device in the foregoing method embodiments. FIG. 13 is a schematic block diagram of a terminal device 800 according to an embodiment of this application. As shown in FIG. 13, the terminal device 800 includes a processing unit 810. The terminal device is referred to as a first terminal device below, and a device communicating with the terminal device is referred to as a second terminal device below.

The processing unit 810 is configured to: when the first terminal device processes a preset service, transmit target data streams between the first terminal device and the second terminal device by using a first communication link and a second communication link.

The first communication link includes at least one Wi-Fi link that complies with a Wi-Fi protocol, the second communication link includes at least one D2D link that complies with a D2D sidelink (sidelink, SL) protocol, the target data streams are data streams corresponding to the preset service, and the preset service is a unidirectional data transmission service or a bidirectional data transmission service.

According to the foregoing solution, when the terminal device supports Wi-Fi and D2D (for example, V2X) communication, the terminal device may communicate with another terminal device in a multi-link collaborative transmission manner such as a Wi-Fi link and a D2D to implement multi-link accelerated transmission in a local area network. This may improve data transmission stability, and increase data transmission rate. In embodiments of this application, device-to-device transmission acceleration is implemented through multi-network and multi-link collaborative transmission, to resolve problems of a low data transmission speed and a long transmission delay in a current device-to-device communication process, and improve user service experience.

Optionally, the target data streams may be transmitted between the first terminal device and the second terminal device by using one Wi-Fi link and one D2D link. Alternatively, the target data streams may be transmitted between the first terminal device and the second terminal device by using a plurality of Wi-Fi links and one D2D link. Alternatively, the target data streams may be transmitted between the first terminal device and the second terminal device by using one Wi-Fi link and a plurality of D2D links. Alternatively, the target data streams may be transmitted between the first terminal device and the second terminal device by using a plurality of Wi-Fi links and a plurality of D2D links.

In actual implementation, the processing unit 810 includes a Wi-Fi chip and a D2D chip. The two chips may be two independent chips, or may be integrated and installed in the first terminal device. The Wi-Fi chip in the first terminal device may exchange information with the D2D chip by using a universal asynchronous receiver/transmitter UART interface.

In actual implementation, at least one Wi-Fi link may be established between the Wi-Fi chip of the first terminal device and a Wi-Fi chip of the second terminal device, and at least one D2D link may be established between the D2D chip of the first terminal device and a D2D chip of the second terminal device. In this way, a multi-link collaborative transmission manner of a Wi-Fi link and a D2D direct communication link may be used between different devices, to implement multi-link accelerated transmission in a local area network.

In an optional embodiment, the processing unit 810 is specifically configured to transmit the target data streams between the first terminal device and the second terminal device through a first interface, where the first interface is an interface used for direct communication between devices. For example, the first interface is a PC5 interface. The first terminal device may directly communicate with the second terminal device by using the PC5 interface.

In an optional embodiment, an operating frequency band of the first communication link is an unlicensed frequency band of 2.4 GHz and/or an unlicensed frequency band of 5 GHz and/or an unlicensed frequency band of 6 GHz; and an operating frequency band of the second communication link is an unlicensed frequency band of 2.4 GHz and/or an unlicensed frequency band of 5 GHz and/or an unlicensed frequency band of 6 GHz.

It should be noted that the first communication link operating on the unlicensed frequency band of 2.4 GHz may be referred to as a 2.4 GHz Wi-Fi link, and the first communication link operating on the unlicensed frequency band of 5 GHz may be referred to as a 5 GHz Wi-Fi link. The second communication link operating on the unlicensed frequency band of 2.4 GHz may be referred to as a 2.4 GHz D2D link, and the second communication link operating on the unlicensed frequency band of 5 GHz may be referred to as a 5 GHz D2D link.

For example, the target data streams may be transmitted between the first terminal device and the second terminal device by using a 2.4 GHz Wi-Fi link and a 2.4 GHz D2D link. Alternatively, the target data streams may be transmitted between the first terminal device and the second terminal device by using a 5 GHz Wi-Fi link and a 2.4 GHz D2D link. Alternatively, the target data streams may be transmitted between the first terminal device and the second terminal device by using a 2.4 GHz Wi-Fi link and a 5 GHz D2D link. Alternatively, the target data streams may be transmitted between the first terminal device and the second terminal device by using a 5 GHz Wi-Fi link and a 5 GHz D2D link.

For example, the target data streams may be transmitted between the first terminal device and the second terminal device by using a 2.4 GHz Wi-Fi link, a 5 GHz Wi-Fi link, and a 2.4 GHz D2D link. Alternatively, the target data streams may be transmitted between the first terminal device and the second terminal device by using a 2.4 GHz Wi-Fi link, a 5 GHz Wi-Fi link, and a 5 GHz D2D link.

For example, the target data streams may be transmitted between the first terminal device and the second terminal device by using a 2.4 GHz Wi-Fi link, a 2.4 GHz D2D link, and a 5 GHz D2D link. Alternatively, the target data streams may be transmitted between the first terminal device and the second terminal device by using a 5 GHz Wi-Fi link, a 2.4 GHz D2D link, and a 5 GHz D2D link.

For example, the target data streams may be transmitted between the first terminal device and the second terminal device by using a 2.4 GHz Wi-Fi link, a 5 GHz Wi-Fi link, a 2.4 GHz D2D link, and a 5 GHz D2D link.

In an optional embodiment, when the preset service is a bidirectional data transmission service, the target data streams include a first data stream sent by the first terminal device to the second terminal device and a second data stream sent by the second terminal device to the first terminal device. The processing unit 810 is specifically configured to:
transmit the first data stream to the second terminal device by using the first communication link, and receive, by using the second communication link, the second data stream transmitted by the second terminal device; or
transmit the first data stream to the second terminal device by using the second communication link, and receive, by using the first communication link, the second data stream transmitted by the second terminal device.

In actual implementation, the Wi-Fi chip of the first terminal device sends the first data stream to the second terminal device by using the first communication link, and the D2D chip of the first terminal device receives, by using the second communication link, the second data stream sent by the second terminal device. Alternatively, the D2D chip of the first terminal device sends the first data stream to the second terminal device by using the second communication link, and the Wi-Fi chip of the first terminal device receives, by using the first communication link, the second data stream sent by the second terminal device.

In an optional embodiment, the first terminal device further includes a display unit. The display unit is configured to display a multi-link icon on a display of the first terminal device, and the multi-link icon indicates that the first terminal device already establishes the first communication link and the second communication link.

In an optional embodiment, the processing unit 810 is configured to: determine, based on first communication capability information and second communication capability, a plurality of communication links supported between the first terminal device and the second terminal device; and determine the first communication link and the second communication link from the plurality of communication links based on transmission requirement information of the preset service. The first communication capability information indicates a communication link supported by the first terminal device, and the second communication capability information indicates a communication link supported by the second terminal device.

In an optional embodiment, the transmission requirement information of the preset service includes throughput rate requirement information and/or delay requirement information. In this case, the processing unit is specifically configured to: when the throughput rate requirement information indicates that a required throughput rate used to transmit the target data streams is greater than or equal to a preset throughput rate threshold, and/or the delay requirement information indicates that a required delay value used to transmit the target data streams is less than a preset delay threshold, determine the plurality of communication links as the first communication link and the second communication link.

According to the foregoing solution, in a transmission scenario in which a high throughput rate and/or a low delay is preferred, in this embodiment of this application, data transmission may be performed by using a maximum transmission capability of the plurality of links supported by two terminal devices, to ensure a transmission effect of a high throughput rate and/or a low delay.

In an optional embodiment, the first terminal device further includes a transceiver unit. The transceiver unit is configured to: discover the second terminal device by using a Bluetooth link; and obtain the second communication capability information from the second terminal device by using the Bluetooth link.

In this way, the terminal device may first discover another terminal device by using Bluetooth, and then negotiate respective transmission capabilities with the another terminal device. If all the terminal devices support multi-link communication, data may be transmitted between the terminal devices by using a plurality of links.

In an optional embodiment, the first terminal device further includes the display unit. The display unit is configured to display first prompt information in response to an operation of initiating a target service by a user, where the first prompt information is used to prompt whether to transmit, by using a plurality of links, a target data stream corresponding to the preset service. The processing unit is specifically configured to: in response to the confirmation operation of the user for the first prompt information, transmit the target data streams between the first terminal device and the second terminal device by using the first communication link and the second communication link.

In actual implementation, the Wi-Fi chip establishes the first communication link with the second terminal device in response to the confirmation operation of the user for the first prompt information, and transmits the target data streams between the first terminal device and the second terminal device by using the first communication link. The D2D chip establishes the second communication link with the second terminal device in response to the confirmation operation of the user for the first prompt information, and transmits the target data streams between the first terminal device and the second terminal device by using the second communication link.

In an optional embodiment, the processing unit is further configured to: when the first terminal device processes a non-preset service, transmit, by using the first communication link, a data stream corresponding to the non-preset service to the second terminal device. In actual implementation, the Wi-Fi chip transmits, by using the first communication link, the data stream corresponding to the non-preset service to the second terminal device.

The terminal device 800 according to this embodiment of this application may correspondingly perform the method described in this embodiment of this application, and the foregoing and other operations and/or functions of the units in the terminal device 800 are respectively used to implement corresponding procedures of the method. For brevity, details are not described herein again.

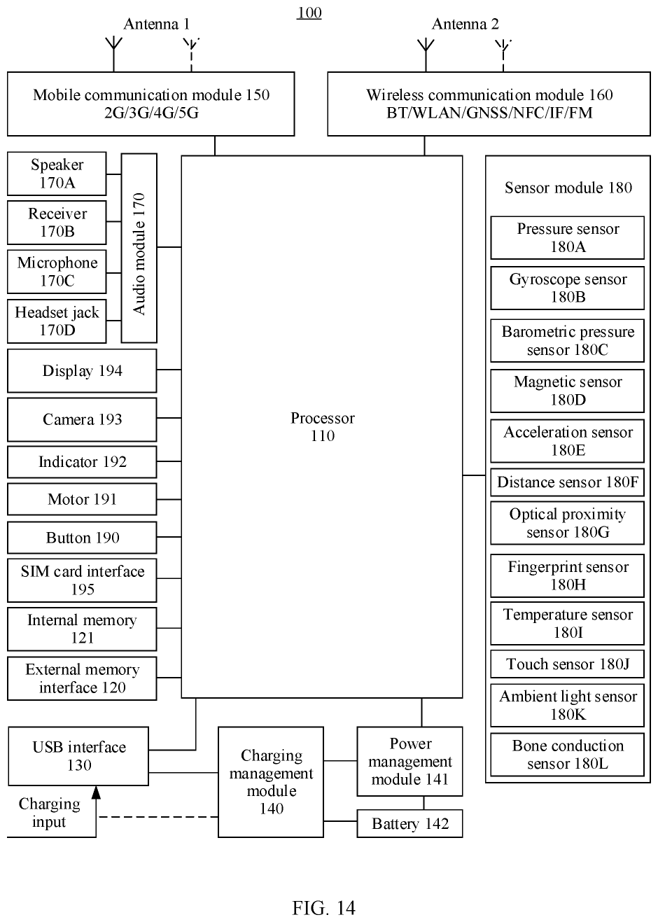

FIG. 14 is a schematic diagram of a structure of a terminal device 100. The terminal device 100 may include a processor 110, an external memory interface 120, an internal memory 121, a universal serial bus (universal serial bus, USB) interface 130, a charging management module 140, a power management unit 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identity module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180I, a touch sensor 180J, an ambient light sensor 180K, a bone conduction sensor 180L, and the like.

It can be understood that the structure illustrated in this embodiment of this application does not constitute a specific limitation on the terminal device 100. In some other embodiments of this application, the terminal device 100 may include more or fewer components than those shown in the figure, or some components may be combined, or some components may be split, or there may be a different component layout. The components shown in the figure may be implemented by using hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU). Different processing units may be independent components, or may be integrated into one or more processors. The controller may be a nerve center and a command center of the terminal device 100. The controller may generate an operation control signal based on instruction operation code and a time sequence signal, to complete control of instruction fetching and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor 110 may directly invoke the instructions or the data from the memory. This avoids repeated access, reduces a waiting time of the processor 110, and improves system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like. It may be understood that an interface connection relationship between the modules illustrated in embodiments of this application is merely an example for description, and does not constitute a limitation on the structure of the terminal device 100. In some other embodiments of this application, the terminal device 100 may alternatively use an interface connection manner different from that in the foregoing embodiment, or may use a combination of a plurality of interface connection manners.

The charging management module 140 is configured to receive a charging input from a charger. The charger may be a wireless charger or a wired charger. In some embodiments of wired charging, the charging management module 140 may receive a charging input of a wired charger through the USB interface 130. In some embodiments of wireless charging, the charging management module 140 may receive a wireless charging input by using a wireless charging coil of the terminal device 100. The charging management module 140 supplies power to the terminal device by using the power management unit 141 while charging the battery 142.

The power management unit 141 is configured to connect to the battery 142, the charging management module 140, and the processor 110. The power management unit 141 receives an input of the battery 142 and/or the charging management module 140, and supplies power to the processor 110, the internal memory 121, an external memory, the display 194, the camera 193, the wireless communication module 160, and the like. The power management unit 141 may be further configured to monitor parameters such as a battery capacity, a battery cycle count, and a battery health state (electric leakage or impedance). In some other embodiments, the power management unit 141 may alternatively be disposed in the processor 110. In some other embodiments, the power management unit 141 and the charging management module 140 may alternatively be disposed in a same device.

A wireless communication function of the terminal device 100 may be implemented by using the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the terminal device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that includes 2G/3G/4G/5G or the like and that is applied to the terminal device 100. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some function modules in the mobile communication module 150 may be disposed in the processor 110. In some embodiments, at least some function modules in the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent component. In some other embodiments, the modem processor may be independent of the processor 110, and is disposed in a same device as the mobile communication module 150 or another function module.

The wireless communication module 160 may provide a wireless communication solution that is applied to the terminal device 100 and that includes a WLAN (such as Wi-Fi), BT, a global navigation satellite system (global navigation satellite system, GNSS), FM, NFC, IR, or a universal 2.4G/5G wireless communication technology. The wireless communication module 160 may be one or more components integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, the wireless communication module 160 may be a Wi-Fi and/or Bluetooth chip and a D2D chip. The terminal device 100 may establish a connection to a chip of a terminal device such as a wireless headset by using the chip, to implement wireless communication and service processing between the terminal device 100 and another terminal device through the connection. The Bluetooth chip may generally support BR/EDR Bluetooth and BLE.

In some embodiments, the antenna 1 and the mobile communication module 150 in the terminal device 100 are coupled, and the antenna 2 and the wireless communication module 160 in the terminal device 100 are coupled, so that the terminal device 100 can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation systems, SBAS).

The terminal device 100 implements a display function by using the GPU, the display 194, the application processor, and the like. The GPU is a microprocessor for image processing, and is connected to the display 194 and the application processor. The GPU is configured to perform mathematical and geometric computation, and render an image. The processor 110 may include one or more GPUs, and the one or more GPUs execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini-LED, a micro-LED, a micro-OLED, a quantum dot light emitting diode (quantum dot light emitting diodes, QLED), or the like. In some embodiments, the terminal device 100 may include one or N displays 194, where N is a positive integer greater than 1.

The terminal device 100 may implement a photographing function by using the ISP, the camera 193, the video codec, the GPU, the display 194, the application processor, and the like.

The ISP is configured to process data fed back by the camera 193. For example, during photographing, a shutter is pressed, light is transferred to a camera photosensitive element through a lens, an optical signal is converted into an electrical signal, and the camera photosensitive element transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 may be configured to capture a static image or a video. An optical image of an object is generated through a lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the terminal device 100 may include one or N cameras 193, where N is a positive integer greater than 1.

The digital signal processor is configured to process a digital signal, and may process another digital signal in addition to the digital image signal. For example, when the terminal device 100 selects a frequency bin, the digital signal processor is configured to perform Fourier transform on frequency bin energy.

The video codec is configured to compress or decompress a digital video. The terminal device 100 may support one or more video codecs. In this way, the terminal device 100 may play back or record videos in a plurality of coding formats, for example, moving picture experts group (moving picture experts group, MPEG)-1, MPEG-2, MPEG-3, and MPEG-4.

The NPU is a neural-network (neural-network, NN) computing processor. The NPU quickly processes input information by referring to a structure of a biological neural network, for example, a transfer mode between human brain neurons, and may further continuously perform self-learning. Applications such as intelligent cognition of the terminal device 100 may be implemented through the NPU, for example, image recognition, facial recognition, speech recognition, and text understanding.

The external memory interface 120 may be used to connect to an external memory card, for example, a micro SD card, to extend a storage capability of the terminal device 100. The external memory card communicates with the processor 110 through the external memory interface 120, to implement a data storage function. For example, files such as music and videos are stored in the external memory card.

The internal memory 121 may be configured to store computer-executable program code, and the executable program code includes instructions. The processor 110 runs the instructions stored in the internal memory 121, to perform various function applications and data processing of the terminal device 100. The internal memory 121 may include a program storage area and a data storage area. The program storage area may store an operating system, an application required by at least one function (for example, a voice playing function or an image playing function), and the like. The data storage area may store data (for example, audio data and an address book) and the like created when the terminal device 100 is used. In addition, the internal memory 121 may include a high-speed random access memory, or may include a nonvolatile memory, for example, at least one magnetic disk storage device, a flash memory, or a universal flash storage (universal flash storage, UFS).

The processor 110 may be configured to execute the foregoing program code, and invoke a related module to implement a function of the terminal device in embodiments of this application, for example, establish a plurality of communication links with another terminal device; and when a preset service (for example, a file transfer service) exists, transmit data of the preset service to another terminal device by using the plurality of communication links.

The terminal device 100 may implement an audio function such as music playing or recording by using the speaker 170A, the receiver 170B, the microphone 170C, and the headset jack 170D in the audio module 170, the application processor, and the like.

The audio module 170 is configured to convert digital audio information into an analog audio signal for output, and is also configured to convert analog audio input into a digital audio signal. The audio module 170 may be further configured to encode and decode an audio signal. In some embodiments, the audio module 170 may be disposed in the processor 110, or some function modules in the audio module 170 are disposed in the processor 110.

The speaker 170A, also referred to as a “loudspeaker”, is configured to convert an audio electrical signal into a sound signal. The terminal device 100 may be used to listen to music or answer a call in a hands-free mode over the speaker 170A.

The receiver 170B, also referred to as an “earpiece”, is configured to convert an electrical audio signal into a sound signal. When a call is answered or speech information is received through the terminal device 100, the receiver 170B may be put close to a human ear to listen to a voice.

The microphone 170C, also referred to as a “mike”, is configured to convert a sound signal into an electrical signal. When making a call or sending a voice message, a user may make a sound near the microphone 170C through the mouth of the user, to input a sound signal to the microphone 170C. At least one microphone 170C may be disposed in the terminal device 100. In some other embodiments, two microphones 170C may be disposed in the terminal device 100, to collect a sound signal and implement a noise reduction function. In some other embodiments, three, four, or more microphones 170C may alternatively be disposed in the terminal device 100, to collect a sound signal, implement noise reduction, identify a sound source, implement a directional recording function, and the like.

The headset jack 170D is configured to connect to a wired headset. The headset jack 170D may be the USB interface 130, or may be a 3.5 mm open mobile terminal platform (open mobile terminal platform, OMTP) standard interface or a cellular telecommunications industry association of the USA (cellular telecommunications industry association of the USA, CTIA) standard interface.

The pressure sensor 180A is configured to sense a pressure signal, and can convert the pressure signal into an electrical signal. In some embodiments, the pressure sensor 180A may be disposed on the display 194. There are a plurality of types of pressure sensors 180A, such as a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The terminal device 100 determines pressure intensity based on the change of the capacitance. When a touch operation is performed on the display 194, the terminal device 100 detects intensity of the touch operation by using the pressure sensor 180A. The terminal device 100 may also calculate a touch location based on a detection signal of the pressure sensor 180A. In some embodiments, touch operations that are performed in a same touch location but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The gyroscope sensor 180B may be configured to determine a motion posture of the terminal device 100. In some embodiments, angular velocities of the terminal device 100 around three axes (for example, x, y, and z axes) may be determined by using the gyroscope sensor 180B. The gyroscope sensor 180B may be configured to implement image stabilization during photographing. For example, when a shutter is pressed, the gyroscope sensor 180B detects an angle at which the terminal device 100 jitters, calculates, based on the angle, a distance for which a lens module needs to compensate, and allows the lens to cancel the jitter of the terminal device 100 through reverse motion, to implement image stabilization. The gyroscope sensor 180B may also be used in a navigation scenario or a somatic game scenario.

The acceleration sensor 180E may detect values of accelerations of the terminal device 100 in various directions (usually on three axes). A magnitude and a direction of gravity may be detected when the terminal device 100 is still. The acceleration sensor 180E may be further configured to identify a posture of the terminal device, and is used in an application such as switching between a landscape mode and a portrait mode or a pedometer.

The distance sensor 180F is configured to measure a distance. The terminal device 100 may measure the distance in an infrared manner or a laser manner. In some embodiments, in a photographing scenario, the terminal device 100 may measure a distance by using the distance sensor 180F, to implement quick focusing.

The optical proximity sensor 180G may include, for example, a light-emitting diode (light-emitting diode, LED) and an optical detector, for example, a photodiode. The light-emitting diode may be an infrared light-emitting diode. The terminal device 100 emits infrared light by using the light-emitting diode. The terminal device 100 detects infrared reflected light from a nearby object by using the photodiode. When sufficient reflected light is detected, the terminal device 100 may determine that there is an object near the terminal device 100. When insufficient reflected light is detected, the terminal device 100 may determine that there is no object near the terminal device 100. The terminal device 100 may detect, by using the optical proximity sensor 180G, that the user holds the terminal device 100 close to an ear for a call, to automatically turn off a screen for power saving. The optical proximity sensor 180G may also be used in a smart cover mode or a pocket mode to automatically perform screen unlocking or locking.

The ambient light sensor 180K is configured to sense ambient light brightness. The terminal device 100 may adaptively adjust brightness of the display 194 based on the sensed ambient light brightness. The ambient light sensor 180K may also be configured to automatically adjust white balance during photographing. The ambient light sensor 180K may also cooperate with the optical proximity sensor 180G to detect whether the terminal device 100 is in a pocket, to avoid an accidental touch.

The barometric pressure sensor 180C is configured to measure barometric pressure. In some embodiments, the terminal device 100 calculates an altitude based on a barometric pressure value measured by the barometric pressure sensor 180C, to assist in positioning and navigation.

The magnetic sensor 180D includes a Hall sensor. The terminal device 100 may detect a displacement of the terminal device 100 by using the magnetic sensor 180D. In some embodiments, the Hall sensor may form a linear trapezoidal magnetic field (or referred to as a slope magnetic field) by using a magnet. A displacement change of a Hall plate in the linear magnetic field is consistent with a change of magnetic field strength, and a formed Hall potential is directly proportional to the displacement. The terminal device 100 obtains the Hall potential to measure the displacement.

The fingerprint sensor 180H is configured to collect a fingerprint. The terminal device 100 may use a feature of the collected fingerprint to implement fingerprint-based unlocking, application lock access, fingerprint-based photographing, fingerprint-based call answering, and the like.

The temperature sensor 180I is configured to detect a temperature. In some embodiments, the terminal device 100 executes a temperature processing policy based on the temperature detected by the temperature sensor 180I. For example, when the temperature reported by the temperature sensor 180I exceeds a threshold, the terminal device 100 reduces performance of a processor located near the temperature sensor 180I, to reduce power consumption and implement heat protection. In some other embodiments, when the temperature is lower than another threshold, the terminal device 100 heats the battery 142, to avoid abnormal shutdown of the terminal device 100 caused by a low temperature. In some other embodiments, when the temperature is lower than still another threshold, the terminal device 100 boosts an output voltage of the battery 142, to avoid abnormal shutdown caused by a low temperature.

The touch sensor 180J is also referred to as a “touch panel”. The touch sensor 180J may be disposed on the display 194, and the touch sensor 180J and the display 194 constitute a touchscreen, which is also referred to as a “touch screen”. The touch sensor 180J is configured to detect a touch operation performed on or near the touch sensor. The touch sensor may transfer the detected touch operation to the application processor to determine a type of the touch event. A visual output related to the touch operation may be provided by using the display 194. In some other embodiments, the touch sensor 180J may alternatively be disposed on a surface of the terminal device 100 at a location different from that of the display 194.

The bone conduction sensor 180L may obtain a vibration signal. In some embodiments, the bone conduction sensor 180L may obtain a vibration signal of a vibration bone of a human vocal-cord part. The bone conduction sensor 180L may also be in contact with a body pulse to receive a blood pressure beating signal. In some embodiments, the bone conduction sensor 180L may also be disposed in a headset, to obtain a bone conduction headset. The audio module 170 may obtain a speech signal through parsing based on the vibration signal that is of the vibration bone of the vocal-cord part and that is obtained by the bone conduction sensor 180L, to implement a speech function. The application processor may parse heart rate information based on the blood pressure beating signal obtained by the bone conduction sensor 180L, to implement a heart rate detection function.

The button 190 includes a power button, a volume button, and the like. The button 190 may be a mechanical button, or may be a touch button. The terminal device 100 may receive a button input, and generate a button signal input related to a user setting and function control of the terminal device 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display 194. Different application scenarios (for example, a time reminder, information receiving, an alarm clock, and a game) may also correspond to different vibration feedback effects. A touch vibration feedback effect may be further customized.

The indicator 192 may be an indicator light, and may be configured to indicate a charging state and a power change, or may be configured to indicate a message, a missed call, a notification, and the like.

The SIM card interface 195 is configured to connect to a SIM card. The SIM card may be inserted into the SIM card interface 195 or detached from the SIM card interface 195, to implement contact with or separation from the terminal device 100. The terminal device 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards can be of a same type or different types. The SIM card interface 195 is also compatible with different types of SIM cards. The SIM card interface 195 is also compatible with an external memory card. The terminal device 100 interacts with a network through the SIM card, to implement functions such as conversation and data communication. In some embodiments, the terminal device 100 uses an eSIM, that is, an embedded SIM card. The eSIM card may be embedded into the terminal device 100, and cannot be separated from the terminal device 100.

It may be understood that the parts shown in FIG. 14 constitute no specific limitation on the terminal device 100. The terminal device 100 may alternatively include more or fewer parts than those shown in the figure, or some components may be combined, or some components may be split, or there may be a different component layout.

The terminal device 100 may be a mobile terminal, or may be a non-mobile terminal. For example, the terminal device 800 may be a mobile phone, a tablet computer, a notebook computer, a palmtop computer, a vehicle-mounted terminal, a wearable device, an ultra-mobile personal computer (ultra-mobile personal computer, UMPC), a netbook, a personal digital assistant (personal digital assistant, PDA), a wireless headset, a wireless bracelet, wireless smart glasses, a wireless watch, an augmented reality (AR)/a virtual reality (VR) device, a desktop computer, a smart home appliance (for example, a TV, a speaker, a refrigerator, an air purifier, an air conditioner, and a rice cooker), or the like. The terminal device 100 may also be collectively referred to as an internet of things (Internet of Things, IoT) device. A device type of the terminal device 100 is not specifically limited in this embodiment of this application.

It should be understood that the terminal device 100 shown in FIG. 14 may be corresponding to the terminal device 700 shown in FIG. 13. The processor 110 in the terminal device 100 shown in FIG. 14 may be corresponding to the processing unit 810 in the terminal device 800 in FIG. 13.

In actual implementation, when the terminal device 100 runs, the processor 110 executes computer-executable instructions in the internal memory 121, to perform the operation steps of the foregoing method by using the terminal device 100.

Optionally, in some embodiments, this application provides a chip system. The chip system includes a Wi-Fi chip and a D2D chip. The chip system is configured to read and execute a computer program stored in a memory, to perform the methods in the foregoing embodiments.

Optionally, in some embodiments, this application provides a terminal device. The terminal device includes a chip system, the chip system includes a Wi-Fi chip and a D2D chip, the chip system is coupled to a memory, and the memory is configured to store a computer program or instructions. The chip system is configured to execute the computer program or the instructions stored in the memory, so that the methods in the embodiments are performed.

Optionally, in some embodiments, an embodiment of this application further provides a computer-readable storage medium. The computer-readable storage medium stores program code. When the computer program code is run on a computer, the computer is enabled to perform the methods in the foregoing embodiments.

Optionally, in some embodiments, an embodiment of this application further provides a computer program product. The computer program product includes computer program code. When the computer program code is run on a computer, the computer is enabled to perform the methods in the foregoing embodiments.

In embodiments of this application, the terminal device or the network device includes a hardware layer, an operating system layer running above the hardware layer, and an application layer running above the operating system layer. The hardware layer may include hardware such as a central processing unit (central processing unit, CPU), a memory management unit (memory management unit, MMU), and a memory (also referred to as a main memory). An operating system at the operating system layer may be any one or more types of computer operating systems that implement service processing through a process (process), for example, a Linux operating system, a Unix operating system, an Android operating system, an iOS operating system, or a Windows operating system. The application layer may include applications such as a browser, an address book, word processing software, and instant messaging software.

A specific structure of an execution body of the method provided in embodiments of this application is not specifically limited in embodiments of this application, provided that a program that records code of the method provided in embodiments of this application can be run to perform communication according to the method provided in embodiments of this application. For example, the method provided in embodiments of this application may be performed by a terminal device, a network device, or a function module that is in a terminal device or a network device and that can invoke and execute the program.

Aspects or features of this application may be implemented as a method, an apparatus, or a product that uses standard programming and/or engineering technologies. The term “product” used in this specification may cover a computer program that can be accessed from any computer-readable component, carrier or medium. For example, the computer-readable storage medium may include but is not limited to a magnetic storage device (for example, a hard disk, a floppy disk, or a magnetic tape), an optical disc (for example, a compact disc (compact disc, CD) or a digital versatile disc (digital versatile disc, DVD)), or a smart card and a flash memory device (for example, an erasable programmable read-only memory (erasable programmable read-only memory, EPROM), a card, a stick, or a key drive).

Various storage media described in this specification may represent one or more devices and/or other machine-readable media that are configured to store information. The term “machine-readable storage medium” may include but is not limited to a wireless channel, and various other media that can store, contain, and/or carry instructions and/or data.

It should be understood that the processor in embodiments of this application may be a central processing unit (central processing unit, CPU), or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

It may be understood that the memory in embodiments of this application may be a volatile memory or a non-volatile memory, or may include a volatile memory and a non-volatile memory. The non-volatile memory may be a read-only memory (read-only memory, ROM), a programmable read-only memory (programmable ROM, PROM), an EPROM, an electrically erasable programmable read-only memory (electrically EPROM, EEPROM), or a flash memory. The volatile memory may be a random access memory (random access memory, RAM). For example, the RAM may be used as an external cache. By way of example and not limitation, the RAM may include the following plurality of forms: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus dynamic random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should further be noted that the memory described in this specification aims to include but is not limited to these memories and any memory of another proper type.

A person of ordinary skill in the art may be aware that, in combination with the examples described in embodiments disclosed in this specification, units and steps may be implemented by electronic hardware or a combination of computer software and electronic hardware. Whether the functions are performed by hardware or software depends on particular applications and design constraints of the technical solution. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate components may or may not be physically separate, and parts displayed as units may or may not be physical units, may be located in one place, or may be distributed on a plurality of network units. Some or all of the units may be selected based on actual requirements to achieve the objectives of the solutions of embodiments.

In addition, function units in embodiments of this application may be integrated into one unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a computer software product. The computer software product is stored in a storage medium, and includes several instructions for instructing a computer device (which may be a personal computer, a server, a network device, or the like) to perform all or some of the steps of the methods described in embodiments of this application. The foregoing storage medium may include any medium that can store program code, such as a USB flash drive, a removable hard disk, a ROM, a RAM, a magnetic disk, or an optical disc.

Unless otherwise defined, all technical and scientific terms used in this specification have same meanings as those usually understood by a person skilled in the art of this application. The terms used in the specification of this application are merely for the purpose of describing specific embodiments, and are not intended to limit this application.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-24. (canceled)

25. A terminal device, wherein the terminal device comprises a wireless fidelity (Wi-Fi) chip and a device-to-device (D2D) chip;
wherein the Wi-Fi chip is configured to:
when the terminal device processes a preset service, establish a first communication link to a second terminal device, and transmit target data streams between the terminal device and the second terminal device by using the first communication link; and
wherein the D2D chip is configured to:
when the terminal device processes the preset service, establish a second communication link to the second terminal device, and transmit the target data streams between the terminal device and the second terminal device by using the second communication link; and
wherein the first communication link comprises at least one Wi-Fi link that complies with a Wi-Fi protocol, the second communication link comprises at least one D2D link that complies with a D2D sidelink (SL) protocol, the target data streams are data streams corresponding to the preset service, and the preset service is a unidirectional data transmission service or a bidirectional data transmission service.

26. The terminal device according to claim 25, wherein
the D2D chip is configured to transmit the target data streams between the terminal device and the second terminal device by using a first interface and by using the second communication link, and wherein the first interface is an interface used for direct communication between devices.

27. The terminal device according to claim 25, wherein:
an operating frequency band of the first communication link is at least one of an unlicensed frequency band of 2.4 GHz, an unlicensed frequency band of 5 GHz, or an unlicensed frequency band of 6 GHz; and
an operating frequency band of the second communication link is an unlicensed frequency band of 2.4 GHz, an unlicensed frequency band of 5 GHz, or an unlicensed frequency band of 6 GHz.

28. The terminal device according to claim 25, wherein:
when the preset service is a bidirectional data transmission service, the target data streams comprise a first data stream sent by the terminal device to the second terminal device and a second data stream sent by the second terminal device to the terminal device; and
the Wi-Fi chip is configured to send the first data stream to the second terminal device by using the first communication link, and the D2D chip is configured to receive, by using the second communication link, the second data stream sent by the second terminal device; or
the D2D chip is configured to send the first data stream to the second terminal device by using the second communication link, and the Wi-Fi chip is configured to receive, by using the first communication link, the second data stream transmitted by the second terminal device.

29. The terminal device according to claim 25, wherein the terminal device further comprises at least one processor;
wherein the at least one processor is configured to:
determine, based on first communication capability information and second communication capability information, a plurality of communication links supported between the terminal device and the second terminal device; and
determine the first communication link and the second communication link from the plurality of communication links based on transmission requirement information of the preset service; and
wherein the first communication capability information indicates a communication link supported by the terminal device, and the second communication capability information indicates a communication link supported by the second terminal device.

30. The terminal device according to claim 29, wherein the transmission requirement information of the preset service comprises at least one of throughput rate requirement information or delay requirement information; and
wherein the at least one processor is configured to:
when at least one of the throughput rate requirement information indicates that a required throughput rate used to transmit the target data streams is greater than or equal to a preset throughput rate threshold, or the delay requirement information indicates that a required delay value used to transmit the target data streams is less than a preset delay threshold, determine the plurality of communication links as the first communication link and the second communication link.

31. The terminal device according to claim 29, wherein the terminal device further comprises a transceiver; and
wherein the transceiver is configured to:
discover the second terminal device by using a Bluetooth link; and
obtain the second communication capability information from the second terminal device by using the Bluetooth link.

32. The terminal device according to claim 25, wherein the terminal device further comprises a display;
wherein the display is configured to display first prompt information in response to an operation of initiating a target service by a user, wherein the first prompt information is used to prompt whether to transmit, by using a plurality of links, the target data streams corresponding to the preset service;
wherein the Wi-Fi chip is configured to:
in response to a confirmation operation of the user for the first prompt information, establish the first communication link with the second terminal device; and
transmit the target data streams between the terminal device and the second terminal device by using the first communication link; and
wherein the D2D chip is configured to:
in response to the confirmation operation of the user for the first prompt information, establish the second communication link with the second terminal device; and
transmit the target data streams between the terminal device and the second terminal device by using the second communication link.

33. The terminal device according to claim 32, wherein the display is further configured to display a multi-link icon, and the multi-link icon indicates that the terminal device already establishes the first communication link and the second communication link.

34. The terminal device according to claim 25, wherein the Wi-Fi chip is further configured to exchange information with the D2D chip by using a universal asynchronous receiver/transmitter (UART) interface.

35. The terminal device according to claim 25, wherein the Wi-Fi chip is further configured to:
when the terminal device processes a non-preset service, transmit, by using the first communication link, a data stream corresponding to the non-preset service to the second terminal device.

36. A method, wherein the method comprises:
when a first terminal device processes a preset service, transmitting target data streams between the first terminal device and a second terminal device by using a first communication link and a second communication link, wherein:
the first communication link comprises at least one wireless fidelity (Wi-Fi) link that complies with a Wi-Fi protocol, the second communication link comprises at least one device-to-device (D2D) link that complies with a D2D sidelink (SL) protocol, the target data streams are data streams corresponding to the preset service, and the preset service is a unidirectional data transmission service or a bidirectional data transmission service.

37. The method according to claim 36, wherein an interface of the second communication link is an interface used for direct communication between devices.

38. The method according to claim 36, wherein:
an operating frequency band of the first communication link is an unlicensed frequency band of 2.4 GHz, an unlicensed frequency band of 5 GHz, or an unlicensed frequency band of 6 GHz; and
an operating frequency band of the second communication link is an unlicensed frequency band of 2.4 GHz, an unlicensed frequency band of 5 GHz, or an unlicensed frequency band of 6 GHz.

39. The method according to claim 36, wherein:
when the preset service is a bidirectional data transmission service, the target data streams comprise a first data stream sent by the first terminal device to the second terminal device and a second data stream sent by the second terminal device to the first terminal device; and
the transmitting target data streams between the first terminal device and a second terminal device by using a first communication link and a second communication link comprises:
sending, by the first terminal device, the first data stream to the second terminal device by using the first communication link, and receiving, by using the second communication link, the second data stream sent by the second terminal device; or
sending, by the first terminal device, the first data stream to the second terminal device by using the second communication link, and receiving, by using the first communication link, the second data stream transmitted by the second terminal device.

40. The method according to claim 36, wherein before the transmitting target data streams between the first terminal device and a second terminal device by using a first communication link and a second communication link, the method further comprises:
determining, by the first terminal device based on first communication capability information and second communication capability information, a plurality of communication links supported between the first terminal device and the second terminal device; and
determining, by the first terminal device, the first communication link and the second communication link from the plurality of communication links based on transmission requirement information of the preset service, wherein the first communication capability information indicates a communication link supported by the first terminal device, and the second communication capability information indicates a communication link supported by the second terminal device.

41. The method according to claim 40, wherein the transmission requirement information of the preset service comprises at least one of throughput rate requirement information or delay requirement information; and
wherein the determining, by the first terminal device, the first communication link and the second communication link from the plurality of communication links based on transmission requirement information of the preset service comprises:
when at least one of the throughput rate requirement information indicates that a required throughput rate used to transmit the target data streams is greater than or equal to a preset throughput rate threshold, or the delay requirement information indicates that a required delay value used to transmit the target data streams is less than a preset delay threshold, determining, by the first terminal device, the plurality of communication links as the first communication link and the second communication link.

42. The method according to claim 40, wherein before the determining, by the first terminal device, a plurality of communication links supported between the first terminal device and the second terminal device, the method further comprises:
discovering, by the first terminal device, the second terminal device by using a Bluetooth link; and
obtaining, by the first terminal device, the second communication capability information from the second terminal device by using the Bluetooth link.

43. The method according to claim 36, wherein before the transmitting target data streams between the first terminal device and a second terminal device by using a first communication link and a second communication link, the method further comprises:
displaying, by the first terminal device, first prompt information in response to an operation of initiating a preset service by a user, wherein the first prompt information is used to prompt whether to transmit, by using a plurality of links, a target data stream corresponding to the preset service; and
wherein the transmitting target data streams between the first terminal device and a second terminal device by using a first communication link and a second communication link comprises:
transmitting the target data streams between the first terminal device and the second terminal device by using the first communication link and the second communication link in response to a confirmation operation of the user for the first prompt information.

44. The method according to claim 36, wherein the method further comprises:
displaying, by the first terminal device, a multi-link icon on a display, wherein the multi-link icon indicates that the first terminal device already establishes the first communication link and the second communication link.
